(19) United States
(12) Patent Application Publication
(10) Pub. No.: US 2026/0273421 A1
(43) Pub. Date: Sep. 17, 2026

(54) Match Playing Method and Apparatus for Round-Based Board Game, Device, and Medium

(71) Applicant: Tencent Technology (Shenzhen) Company Limited, Shenzhen (CN)

(72) Inventors: Yanan Zhang, Shenzhen (CN); Lu Chen, Shenzhen (CN); Jiayu Yang, Shenzhen (CN)

(21) Appl. No.: 19/673,208

(22) Filed: May 11, 2026

Related U.S. Application Data
(63) Continuation of application No. PCT/CN2025/074530, filed on Jan. 24, 2025.

(30) Foreign Application Priority Data
Feb. 8, 2024 (CN) 2024101782457

(51) Int. Cl. A63F 13/822; A63F 13/52; A63F 13/58; A63F 13/795

(52) U.S. Cl. CPC A63F 13/822; A63F 13/52; A63F 13/58; A63F 13/795

(57) ABSTRACT

Provided are a match playing method and apparatus for a round-based board game, a device, and a medium, and relate to the field of human-computer interaction. The method includes: displaying cards held by this party, the cards including at least two card types; additionally displaying a first card based on determining that a first obtaining condition corresponding to a first card type is satisfied, the first card being a card of the first card type, the first card type being any one of the at least two card types, and different card types corresponding to different obtaining conditions; and displaying, in response to a use operation for the first card, that the first card acts on a game match of the round-based board game.

### RELATED APPLICATIONS

This application claims priority to PCT/CN2025/074530, filed on Jan. 24, 2025, which claims priority to Chinese Patent Application 202410178245.7, entitled "MATCH PLAYING METHOD AND APPARATUS FOR PLAYING ROUND-BASED BOARD GAME, DEVICE, AND MEDIUM" filed on Feb. 08, 2024, each of which is incorporated herein by reference in its entirety.

### FIELD OF THE TECHNOLOGY

This application relates to the field of human-computer interaction, and in particular, to a method and apparatus for playing a round-based board video game, a device, and a medium.

### BACKGROUND OF THE DISCLOSURE

A round-based board video game is a new type of board game. After both opposing players place pieces in a chessboard area of a chessboard, a game application automatically controls the pieces on the chessboard to engage in a match and displays a match result.

The round-based board game, as a strategy-based board game, provides players with strategic mechanisms in a plurality of dimensions. The players need to comprehensively consider the strategic mechanisms in the dimensions when making a match decision. For example, the players need to consider deployed pieces, equipment of the pieces, buff effects brought by a faction composition of the deployed pieces, and chess player skills.

### SUMMARY

This application provides a match playing method and apparatus for a round-based board game, a device, and a medium, to improve efficiency of human-computer interaction. The technical solutions are as follows:

According to one aspect, a match playing method for a round-based board game is provided. The method is performed by a computer device and includes: displaying cards held by this party, the cards including at least two card types; additionally displaying a first card in a case that a first obtaining condition corresponding to a first card type is satisfied, the first card being a card of the first card type, the first card type being any one of the at least two card types, and different card types corresponding to different obtaining conditions; and displaying, in response to a use operation for the first card, that the first card acts on a game match of the round-based board game.

According to another aspect, a match playing apparatus for a round-based board game is provided. The apparatus includes: a display module, configured to display cards held by this party, the cards including at least two card types, the display module being configured to additionally display a first card in a case that a first obtaining condition corresponding to a first card type is satisfied, the first card being a card of the first card type, the first card type being any one of the at least two card types, and different card types corresponding to different obtaining conditions; and the display module being configured to display, in response to a use operation for the first card, that the first card acts on a game match of the round-based board game.

According to another aspect, this application provides a computer device, including a processor and a memory. The memory has at least one instruction, at least one program, a code set, or an instruction set stored therein, and the at least one instruction, the at least one program, the code set, or the instruction set is loaded and executed by the processor, to cause the computer device to implement the match playing method for a round-based board game according to the foregoing aspect.

According to another aspect, this application provides a non-transitory non-volatile computer-readable storage medium, having at least one program stored therein. The at least one program is loaded and executed by a processor, to cause a computer to implement the match playing method for a round-based board game according to the foregoing aspect.

According to another aspect, this application provides a computer program product or a computer program, including computer instructions. The computer instructions are stored in a non-transitory non-volatile computer-readable storage medium. A processor of a computer device reads the computer instructions from the computer-readable storage medium, and executes the computer instructions, to cause the computer device to perform the match playing method for a round-based board game according to the foregoing implementations.

The strategic mechanisms in the round-based board game are presented in the form of cards, to provide a plurality of different types of cards. Cards obtained by a player are uniformly displayed, and a match decision-making operation in any dimension is performed by playing a corresponding card. This simplifies a manner of making a match decision. Different strategic mechanisms are implemented by using different card types, and different obtaining conditions are set for different card types, to correspondingly satisfy different obtaining manners for battle elements, such as a piece, equipment, an effect, and a skill, in different strategic mechanisms. In the game match, the player can quickly and conveniently perform decision-making operations of different strategic mechanisms only by observing held cards and performing use operations for the cards without paying attention to other information. This helps the player quickly make a match decision in the fast-paced round-based board game, to improve human-computer interaction efficiency. In this way, match duration of the game match is shortened, service duration of a server for the game match is shortened, and resources of the server are saved.

### BRIEF DESCRIPTION OF THE DRAWINGS

FIG. 1 is a structural block diagram of a computer system according to an example of this application.

FIG. 2 is a flowchart of a match interaction method for a round-based board game according to an example of this application.

FIG. 3 is a schematic interface diagram of a match interface of a round-based board game according to an example of this application.

FIG. 4 is a schematic card diagram of a piece card according to an example of this application.

FIG. 5 is a schematic card diagram of an effect card according to an example of this application.

FIG. 6 is a schematic card diagram of an equipment card according to an example of this application.

FIG. 7 is a schematic card diagram of a chess player card according to an example of this application.

FIG. 8 is a flowchart of a match interaction method for a round-based board game according to another example of this application.

FIG. 9 is a schematic interface diagram of a chess player selection interface according to an example of this application.

FIG. 10 is a schematic interface diagram of a match interface of a preparation phase according to an example of this application.

FIG. 11 is a schematic interface diagram of a preparation phase in which a card is played according to an example of this application.

FIG. 12 is a schematic diagram of an upgrade process of an upgrade button according to an example of this application.

FIG. 13 is a schematic interface diagram of a match interface of a battle phase according to an example of this application.

FIG. 14 is a schematic interface diagram of a match interface of a battle phase according to another example of this application.

FIG. 15 is a schematic interface diagram of a settlement interface according to an example of this application.

FIG. 16 is a method flowchart of a match playing method for a round-based board game according to another example of this application.

FIG. 17 is a schematic interface diagram of a match playing method for a round-based board game according to another example of this application.

FIG. 18 is a schematic diagram of an effect card in a match playing method for a round-based board game according to another example of this application.

FIG. 19 is a schematic diagram of an equipment card in a match playing method for a round-based board game according to another example of this application.

FIG. 20 is a schematic diagram of a chess player card in a match playing method for a round-based board game according to another example of this application.

FIG. 21 is a method flowchart of a match playing method for a round-based board game according to another example of this application.

FIG. 22 is a method flowchart of a match playing method for a round-based board game according to another example of this application.

FIG. 23 is a method flowchart of a match playing method for a round-based board game according to another example of this application.

FIG. 24 is a method flowchart of a match playing method for a round-based board game according to another example of this application.

FIG. 25 is a schematic interface diagram of a match playing method for a round-based board game according to another example of this application.

FIG. 26 is a schematic diagram of a match playing method for a round-based board game according to another example of this application.

FIG. 27 is a schematic diagram of a match playing method for a round-based board game according to another example of this application.

FIG. 28 is a schematic diagram of a match playing method for a round-based board game according to another example of this application.

FIG. 29 is a method flowchart of a match playing method for a round-based board game according to another example of this application.

FIG. 30 is an apparatus block diagram of a match playing apparatus for a round-based board game according to another example of this application.

FIG. 31 is a block diagram of a terminal according to another example of this application.

### DESCRIPTION OF EMBODIMENTS

To make the objectives, technical solutions, and advantages of this application clearer, the following further describes implementations of this application in detail with reference to the accompanying drawings.

First, terms involved in the examples of this application are introduced.

Round-based board game: it refers to a board game in which "pieces" are deployed in advance before a chess match starts, and the "pieces" can automatically engage in a battle according to the preset deployment during the battle. A "piece" is typically represented by a virtual character, and for example, may be referred to as a virtual hero. During the battle, the virtual character automatically releases various skills for the battle. The battle is typically round-based. When all "pieces" of a party are defeated (that is, a health point of a virtual character is reduced to zero), this party is the loser of a current round of battle. In some examples, in addition to "piece-type virtual characters" for a battle, two parties of the battle are each provided with a chess player character representing a current user engaging in the battle. The chess player character cannot be moved to a battle area or a candidate piece area as a "piece". The chess player character is also provided with a hit point (or a hit point). The health point of the chess player character is correspondingly reduced (if the battle is lost) or not changed (if the battle is won) according to a battle result of each round. When the health point of the virtual character is reduced to zero, the user corresponding to the chess player character is eliminated from the battle, and remaining users continue the battle. In an example, the round-based board game includes auto chess.

Auto chess: it refers to a multiplayer round-based competitive game featuring collectible and swappable hero pieces in a match. For example, a total of eight or six players play the game and each occupy an area of a chessboard. Two of the plurality of players engage in a one-versus-one battle. Each round of a battle match includes two phases: a preparation phase and a battle phase. In the preparation phase, a user purchases pieces (heroes) from a shop and deploy the pieces on a chessboard. In the battle phase, pieces of two parties are fixed and automatically engage in the battle until all pieces of one party are defeated. The party whose pieces are all defeated is the loser of the current round, and a hit point of the loser is reduced by a specific amount. Remaining players continuously engage in game rounds, and battle against new opponents until the health point of the player is equal to or less than zero, at which the player is eliminated from the match. The sole remaining player at the end wins the game (ranked first place).

Chessboard: it refers to an area of a battle interface of a round-based board game that is configured to prepare a battle and perform a battle. The chessboard may be any one of a two-dimensional virtual chessboard, a 2.5-dimensional virtual chessboard, and a three-dimensional virtual chessboard. This is not limited in this application.

A chessboard of conventional auto chess is divided into a battle area and a candidate piece area. The battle area includes several squares having a same size, and the squares are configured to place pieces engaging in a battle during the battle. The candidate piece area includes several candidate piece positions, the candidate piece positions are configured to place candidate pieces, and the candidate pieces do not engage in the battle during the battle and can be dragged and placed in the battle area in the preparation phase. The chessboard area according to the examples of this application does not include the candidate piece area and only includes the battle area.

Regarding a manner of setting the squares in the battle area, in some examples, the battle area includes n (rows) × m (columns) squares. For example, n is an integer multiple of 2, and two adjacent rows of squares are aligned, or two adjacent rows of squares are staggered. In addition, the battle area is uniformly divided into two parts according to rows, which are a battle area of this party and a battle area of an opposing party, and users engaging in the battle are respectively located on an upper side and a lower side of the battle interface. In the preparation phase, the users can place pieces only in the battle area of this party. In some other examples, the battle area is uniformly divided into two parts according to columns, which are a battle area of this party and a battle area of an opposing party, and users engaging in the battle are respectively located on a left side and a right side or an upper side and a lower side of the battle interface. A shape of the square may be any one of a square, a rectangle, a circle, and a hexagon. The shape of the square is not limited in the examples of this application.

Card: it is a common term of a game type, and derives from a desktop game. Different from directly manipulating piece models in chess, cards are configured to carry game content on the cards. Compared with the piece, the card is more convenient to carry some text descriptions, card attribute information, and transmission of some key values. "Cardification" refers to transforming hero resources into card resources, to make it easier for players to read card effects, classify cards, and carry transmission of information across more dimensions.

Energy: it is a type of game resource. In this application, energy is defined as a resource for a player to play a card. When a card is played, an amount of energy corresponding to a value indicated on the card is consumed.

Equipment: in an auto chess game, typically, each piece can be equipped with three pieces of equipment (or another quantity of pieces of equipment). Equipment can provide a hero with attributes or effects such as attack power, defense power, health points, healing, penetration, and shields. In the related art, an auto chess game typically includes a creeping round. After defeating a neutral creep, a player obtains equipment dropped by the neutral creep and collects the equipment into a backpack. Alternatively, a plurality of parts may be assembled, to obtain higher-quality equipment.

Chess player: it refers to a virtual character played by a player. Chess players have different special abilities, which can help a player better play a game. In some examples, the chess player may alternatively be referred to as a chess player virtual character, a chess player character, or the like.

The round-based board game, as a strategy-based board game, provides players with strategic mechanisms in a plurality of dimensions. The players need to comprehensively consider the strategic mechanisms in the dimensions when making a match decision. For example, the players need to consider deployed pieces, equipment of the pieces, buff effects brought by a faction composition of the deployed pieces, and chess player skills.

In the related art, operating areas corresponding to the plurality of different strategic mechanisms are respectively located at different positions of a match interface. For example, a piece preparation area is located on a lower side of the match interface. In the piece preparation area, the players can select pieces for the battle, and perform operations such as piece purchase and piece upgrade. An equipment area is located on a right side of the match interface. In the equipment area, the players can equip the pieces with different equipment. A chess player skill selection area is located on a left side of the match interface.

However, the gameplay pace of the round-based board game is usually fast, and both parties need to make match decisions within a very short interval between rounds. Various complicated strategic mechanisms are dispersedly arranged on the match interface, which is very unfavorable for the players to make match decisions. Presentation of the information on the match interface is chaotic, resulting in low human-computer interaction efficiency and long match duration of the game match. In addition, a server needs to provide services for the game match for an extended period, resulting in high resource consumption of the server.

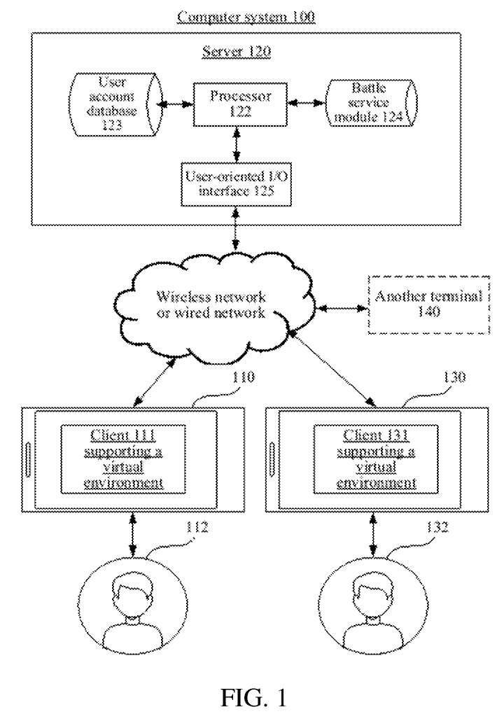

FIG. 1 is a structural block diagram of a computer system according to an example of this application. A computer system 100 includes: a first terminal 110, a server 120, and a second terminal 130.

The first terminal 110 is equipped with and runs a client 111 supporting a virtual environment. The client 111 may be a round-based board game program. When the first terminal 110 runs the client 111, a user interface of the client 111 is displayed on a screen of the first terminal 110. The client 111 may be a client of an auto chess game. The first terminal 110 is a terminal used by a first user 112. In a preparation phase of a match, the first user 112 deploys pieces in a battle area of a chessboard through the first terminal 110. In a battle phase, the first terminal 110 or the server 120 automatically controls the pieces to engage in a battle according to attributes, skills, and a deployment of the pieces in the battle area.

The virtual environment refers to an environment provided (or displayed) by the client when the client runs on the terminal. The virtual environment may be a two-dimensional virtual environment, a 2.5-dimensional virtual environment, a three-dimensional virtual environment, or the like. The virtual environment may be a simulated environment of a real world, or may be a semi-simulated and semi-fictional environment, or may be a completely fictional environment.

The second terminal 130 is equipped with and runs a client 131 supporting a virtual environment. The client 131 may be a round-based board game program. When the second terminal 130 runs the client 131, a user interface of the client 131 is displayed on a screen of the second terminal 130. The client 131 may be a client of an auto chess game. The second terminal 130 is a terminal used by a second user 132. In the preparation phase of the match, the second user 132 deploys pieces in a battle area of the chessboard through the second terminal 130. In the battle phase, the second terminal 130 or the server 120 automatically controls the pieces to engage in the battle according to attributes, skills, and a deployment of the pieces in the battle area.

In an example, the pieces deployed by the first user 112 through the first terminal 110 and the pieces deployed by the second user 132 through the second terminal 130 are located in different battle areas of a same chessboard, that is, the first user 112 and the second user 132 are located on the same chessboard of a same match. Alternatively, the pieces deployed by the first user 112 through the first terminal 110 and the pieces deployed by the second user 132 through the second terminal 130 are located on different chessboards, that is, the first user 112 and the second user 132 are located on different chessboards of a same match. In an example, six user accounts engage in a match of a round-based board game. In each round, the six user accounts are paired into three pairs in each round, and the two user accounts paired together engage in a battle on a same chessboard in this round.

In an example, the client equipped in the first terminal 110 is same as the client equipped in the second terminal 130, or the clients equipped in the two terminals are clients of a same type on different operating system platforms (Android or iOS). The first terminal 110 may generally refer to one terminal among a plurality of terminals, and the second terminal 130 may generally refer to another terminal among a plurality of terminals. In this example, a description is made by only using the first terminal 110 and the second terminal 130 as an example. A device type of the first terminal 110 may be the same as or different from a device type of the second terminal 130. The device type includes at least one of a smartphone, a tablet computer, an e-book reader, a moving picture experts group audio layer III (MP3) player, a moving picture experts group audio layer IV (MP4) player, a laptop portable computer, and a desktop computer. In the following examples, a description is made by using an example in which the terminal includes a smartphone.

A person skilled in the art may understand that more or fewer terminals may be provided. For example, only one terminal (that is, a user battles against artificial intelligence) may be provided, or six, eight, or more terminals may be provided. The quantity of terminals and the device type are not limited in the examples of this application.

FIG. 1 shows only two terminals, but a plurality of other terminals 140 may access the server 120 in different examples. In an example, one or more terminals 140 are further provided and are terminals corresponding to a developer. The terminal 140 is equipped with a development and editing platform of a client supporting a virtual environment. The developer may edit and update the client on the terminal 140, and transmit an updated client package to the server 120 over a wired or wireless network. The first terminal 110 and the second terminal 130 may download the updated client package from the server 120 to update the client.

The first terminal 110, the second terminal 130, and the another terminal 140 are connected to the server 120 via a wireless network or a wired network.

The server 120 includes at least one of one server, a plurality of servers, a cloud computing platform, or a virtualization center. The server 120 is configured to provide a backend service for a client supporting a virtual environment (such as a client of a round-based board game/a client of an auto chess game). In an example, the server 120 is responsible for primary computing work, and the terminal is responsible for secondary computing work. Alternatively, the server 120 is responsible for secondary computing work, and the terminal is responsible for primary computing work. Alternatively, the server 120 and the terminal perform collaborative computing using a distributed computing architecture.

In an example, the server 120 includes a processor 122, a user account database 123, a battle service module 124, and a user-oriented input/output (I/O) interface 125. The processor 122 is configured to load an instruction stored in the server 120, and process data in the user account database 123 and the battle service module 124. The user account database 123 is configured to store data of user accounts used by the first terminal 110, the second terminal 130, and the another terminal 140, for example, avatars of the user accounts, nicknames of the user accounts, combat power indexes of the user accounts, and service areas in which the user accounts are located. The battle service module 124 is configured to provide a plurality of battle rooms for users to battle against each other. The user-oriented I/O interface 125 is configured to establish a communication with the first terminal 110 and/or the second terminal 130 via a wireless network or a wired network for data exchange.

The examples of this application provide a round-based board game based on a card operation (auto chess). Various complex operations such as shop purchase, shop upgrade, piece preparation, piece deployment, piece upgrade, and piece equipment involved in conventional auto chess are all simplified into a process of playing cards. The card-based gameplay process is simple, and is suitable for use on a small-screen terminal such as a mobile phone or a tablet. In addition, a three-dimensional model of a virtual piece can carry only limited text information, and a face of the card can carry more information such as "label", "tag", "attribute", and "entry effect", to improve utilization efficiency of a display area in which the card is located.

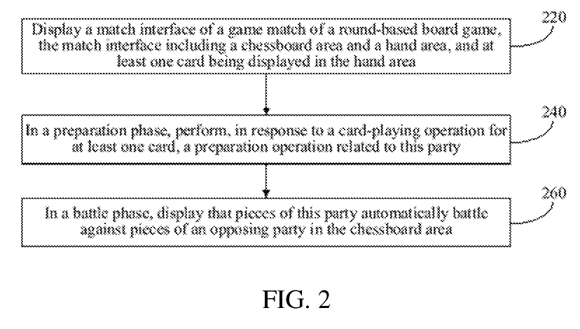

FIG. 2 is a flowchart of a match interaction method for a round-based board game according to an example of this application. The method may be performed by a computer device, and the computer device may include a terminal or a server. In this example, a description is made by using an example in which the method is performed by a terminal, and the terminal runs a client supporting a round-based board game. The method includes operation 220 to operation 260 below.

Operation 220: Display a match interface of a game match of a round-based board game, the match interface including a chessboard area and a hand area, and at least one card being displayed in the hand area.

The match interface refers to an interface on which two player objects perform a round-based battle in the game match of the round-based board game. The player object may be understood as at least one concept of a user, an account, a user account, a player, a chess player, a chess player virtual character, a chess player character, and a virtual chess player.

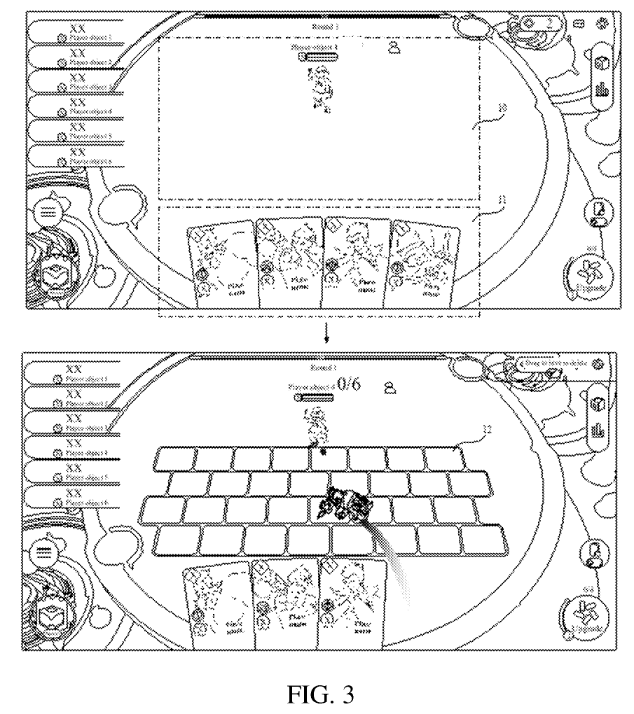

With reference to FIG. 3, the match interface includes a chessboard area 10 and a hand area 11.

The chessboard area 10 is configured to accommodate at least one piece of this party and at least one piece of an opposing party that engage in a battle. The chessboard area 10 includes a plurality of squares 12 arranged in an array, and these squares 12 are always displayed or are displayed only in some occasions. In an example, the chessboard area 10 is a two-dimensional chessboard or a three-dimensional chessboard. In this example, a description is made by using an example in which the chessboard area 10 is a three-dimensional chessboard viewed from a top-down perspective. The three-dimensional chessboard herein means that the chessboard is located in a three-dimensional environment, rather than that the chessboard needs to be in a three-dimensional form.

The hand area 11 is configured to display at least one card held by or dealt to a player object of this party. The at least one card is typically a plurality of cards. The at least one card includes at least one of a card automatically drawn or dealt by a backend program to the player object of this party, a card obtained after some cards having a card-drawing effect are played, and a chess player card obtained through a chess player skill. A quantity of the plurality of cards has an upper limit. For example, up to 8 cards are held, and any excess cards are automatically discarded.

In addition, the at least one card is deployed in a fan shape in the hand area 11, and a deployment order may be determined according to at least one factor of draw time, a card type, a quantity of cards of a same type, a quantity of a same card, and card quality. Card quality of a card is configured for measuring a comprehensive value of the card in the round-based board game. Higher card quality of the card indicates a greater comprehensive value of the card in the round-based board game, and also indicates a higher probability that a player object using the card wins in the round-based board game. The card quality of the card may be set by a developer according to experience, or may be flexibly adjusted according to game rules of the round-based board game. This is not limited in the examples of this application. In an example, the quantity of the at least one card held by the player object of this party has an upper limit, for example, up to 8 or 10 cards are held, and any excess cards are discarded when the quantity reaches the upper limit. The player object of this party may play all or some cards in each round of battle. In an example, in each round of battle, the player object of this party may further swap all or some cards. In an example, different cards have different card types. Different card types have different preparation functions. In some examples, different cards may alternatively have a same card type, that is, the player object of this party may hold a plurality of cards of a same card type.

A battle match of the round-based board game includes at least one round. Each round includes a preparation phase and a battle phase. In some examples, a battle match may alternatively be referred to as a game match.

Operation 240: In a preparation phase, perform, in response to a card-playing operation for at least one card, a preparation operation related to this party.

The card-playing operation refers to an operation of playing one or more held cards. For example, the card-playing operation is an operation of dragging a selected card toward the chessboard area. Alternatively, the card-playing operation includes a first click/tap operation and a second click/tap operation. The first click/tap operation is an operation of clicking/tapping to select a card, and the second click/tap operation is an operation of clicking/tapping a square in the chessboard area. Alternatively, the card-playing operation includes a double-click/double-tap operation for the selected card. Alternatively, the card-playing operation includes a slide operation generated on the selected card. A specific form of the card-playing operation is not limited in the examples of this application. In some examples, an intelligent card-playing recommendation function may further be provided, which plays cards on behalf of the player object of this party in some rounds. For example, in the first few rounds for a novice player, the client may implement the intelligent card-playing recommend function.

The at least one piece of this party is a virtual piece engaging in the battle in at least one round (including a current round). In a case that the chessboard area is a two-dimensional chessboard, the virtual piece is also a two-dimensional piece and is displayed as a two-dimensional icon or a two-dimensional image. In a case that the chessboard area is a three-dimensional chessboard, the virtual chessboard is also a three-dimensional piece and is displayed as a three-dimensional model or a three-dimensional image. In an initial state, the quantity of pieces of this party located in the chessboard area may be zero, and the player object of this party adds, deletes, or replenishes pieces in the chessboard area. A piece of this party that has not been defeated in a previous round may be automatically used in a next round.

A display state of the selected card is different from a display state of an unselected card. In an example, the selected card has a prominent display effect. The prominent display effect includes: a bold border, a highlighted border, a dynamic border, and moving the card from a deployment position in a card queue toward the chessboard area by a preset distance.

The preparation operation includes at least one of: adding pieces of this party, reducing pieces of this party, upgrading a piece of this party, adding equipment to a piece of this party, reducing equipment from a piece of this party, and adding a buff effect to a piece of this party.

Because different card types have different effects, the preparation operation is performed on at least one piece of this party in the chessboard area based on a card type of the selected card.

In the preparation phase, the player object of this party deploys at least one piece of this party in the chessboard area, and a player object of the opposing party deploys at least one piece of the opposing party in the chessboard area.

Operation 260: In a battle phase, display that pieces of this party automatically battle against pieces of an opposing party in the chessboard area.

A process in which the pieces of this party and the pieces of the opposing party automatically engage in the battle in the chessboard area does not require manual control by the player object of this party. The client or the server automatically controls, based on factors such as square positions of the pieces of both parties on the chessboard, attributes of the pieces, levels of the pieces, skills of the pieces, and enhanced attributes of combinations of the pieces, the pieces to engage in the battle until all pieces of one party are defeated.

Both the player object of this party and the player object of the opposing party have health points. After this round ends, the health point of the player object of the loser is reduced by a specific amount. The specific amount may be determined based on a quantity of remaining pieces of the winner, or may be a fixed value. This is not limited in this example.

In conclusion, in the method according to this example, by introducing the "card" mechanism into the round-based board game, a plurality of preparation operations are simplified and integrated in the process of playing a plurality of cards. The concept of a shop is eliminated, and the player no longer needs to perform a plurality of interactions between various sub-areas, such as the shop, the piece preparation area, and the piece battle area, of the conventional battle interface, to obtain and upgrade pieces and engage in the battle. The conventional process in which a user needs to actively select and purchase pieces is changed into a process of passively receiving dealt cards. The game system completes some tedious operations instead of the user, and the user only needs to perform the card-playing operation basically the same as that in a card game, to complete a plurality of preparation operations. This improves human-computer interaction efficiency, shortens match duration of a game match, shortens service duration of the server for the game match, and saves resources of the server.

In particular, when the round-based board game is operated on a small-screen terminal such as a mobile phone or a tablet, the player can complete a plurality of preparation operations based on limited operations in the hand area. Compared with conventional auto chess, the method according to this example can significantly enhance human-computer interaction efficiency.

### Classification of card types

In some examples, the card type includes at least one of a piece card, an effect card, an equipment card, and a chess player card. In some examples, a card of each card type is a two-dimensional card. A card characteristic of the two-dimensional card enables the two-dimensional card to naturally carry more text information and icon information. Therefore, compared with a conventional three-dimensional piece, the two-dimensional card can increase an amount of information carried in a limited display range on a small-screen terminal and improve information transmission efficiency.

### Piece card

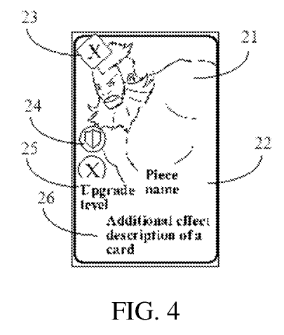

The piece card is a card configured to summon a piece of this party in the chessboard area or upgrade a piece level of a piece of this party. FIG. 4 is a schematic card diagram of a piece card. The piece card displays at least one piece of the following information: a card image 21, a piece name 22, an energy value 23 consumed when the card is played, a piece type or faction 24 to which the card belongs, an increased level 25 of the piece after the card is played, and an additional effect description 26 of the card. The piece involved in the information displayed by the piece card is a piece corresponding to the piece card. The piece corresponding to the piece card refers to a piece summoned by the piece card or a piece whose level is upgraded by the piece card. In some examples, the piece may alternatively be referred to as a virtual piece.

The piece image 21 may be at least one of an avatar, an icon, a half-body image, a full-body image, and a presentation animation of the virtual piece. In FIG. 4, a description is made by using an example in which the piece image 21 is a half-body image of the virtual piece.

The piece name 22 is a name of the virtual piece. An example in which the virtual piece is a hero is used, and the name of the virtual piece is a name of the hero.

The energy value 23 refers to an energy value consumed when the piece card is played. The energy value is a non-negative number. For example, the energy value may be an integer or a decimal. Energy is a resource in the round-based board game. In an example, different amounts of energy need to be consumed when piece cards of different qualities are played. For example, when five piece cards of different qualities are played, 0, 1, 2, 3, and 4 energy points need to be consumed respectively. In an example, energy values consumed by different piece cards may be regularly or irregularly adjusted based on actual game conditions, to maintain fairness and appeal of the game.

The piece type in the piece type or faction 24 is a classification attribute of a character played by the piece during the battle. In an example, different pieces may be classified into at least one piece type of a tank, a warrior, an assassin, a mage, a marksman, and a support. The faction in the piece type or faction 24 is a classification attribute indicating that the pieces belong to a same piece group in a virtual world. In an example, different pieces may be classified into at least one of the following factions: Great Wall, Third Lands, Xuan Yong, Organism, Rao Tian, Chang'an. For example, in the virtual world, two pieces belonging to Great Wall guards belong to the faction of Great Wall. In different examples, the piece type and the faction may be considered as a same classification attribute. In this example, a description is made by using an example in which the piece type and the faction are different classification attributes.

The increased level 25 of the piece after the card is played refers to an upgraded piece level of a piece having the same name (namely, the same piece) after the card is played in a case that the piece having the same name has existed in the chessboard area. For example, if the level 25 is 3 levels, and an original level of the piece having the same name is level 2, the piece having the same name is upgraded to level 5 after the card is played. The piece having the same name includes a piece whose piece name is the same as that of the piece card. In an example, the piece having the same name is upgraded to different levels after piece cards of different qualities are played. For example, after five piece cards of different qualities are played, the level of the piece having the same name is upgraded by 1 level, 2 levels, 3 levels, 4 levels, and 5 levels, respectively.

The additional effect description 26 of the card is an effect description of an additional effect of the card. The additional effect may be triggered to take effect when the card is played, or may take effect when a trigger condition is satisfied during the battle. For example, an additional effect of a piece card 1 is that: when a piece 1 corresponding to the piece card 1 exists on the chessboard, each time another piece of this party in the chessboard area is sold, a piece of this party whose piece type is "tank" is randomly selected, and a piece level of the randomly selected piece of this party is increased by a first value. The first value is equal to a half of a level of the sold piece. In some examples, the additional effect may alternatively be referred to as an exclusive skill.

### Effect card

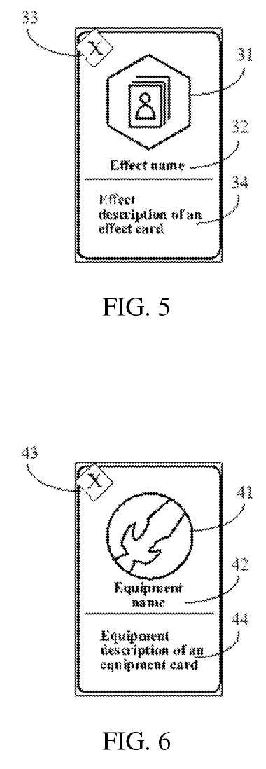

The effect card is a card configured to apply an effect to at least one game factor in the game match. The at least one game factor includes a piece, a skill, equipment, a buff effect, a level, a battle process, a card obtaining process, and the like. FIG. 5 is a schematic diagram of an effect card. The effect card displays at least one piece of the following information: an effect icon 31, an effect name 32, an energy value 33 consumed when the card is played, and an effect description 34 of the effect card.

The effect icon 31 may be an icon configured to represent a buff effect of the effect card. In FIG. 5, a description is made by using an example in which the icon has a hexagonal border. The effect name 32 is a name of the effect card or a name of the buff effect.

The energy value 33 refers to an energy value consumed when the effect card is played. The energy value is a non-negative number. For example, the energy value may be an integer or a decimal. Energy is a resource in the round-based board game. In an example, different amounts of energy need to be consumed when effect cards of different qualities are played. For example, when five effect cards of different qualities are played, 0, 1, 2, 3, and 4 energy points need to be consumed respectively. In an example, energy values consumed by different effect cards may be regularly or irregularly adjusted based on actual game conditions, to maintain fairness and appeal of the game.

The effect description 34 of the effect card is configured for describing an effect of the effect card after use. The effect of the effect card after use includes, but is not limited to, at least one of the following:
1: increasing a probability that a chess player of this party obtains a piece card and/or a quantity of obtained piece cards;
2: increasing a probability that the chess player of this party obtains a piece card having the same name as a deployed piece and/or a quantity of obtained piece cards;
3: reducing energy consumption required for obtaining a piece card by the chess player of this party;
4: increasing a quantity of piece cards exchanged for by the chess player of this party.
5: reducing energy consumption required for exchanging for a piece card by the chess player of this party;
6: increasing a piece level of at least one deployed piece;
7: adding equipment to at least one deployed piece;
8: increasing an equipment level of at least one deployed piece;
9: reducing energy consumption during card playing/card swapping;
10: increasing a probability of obtaining some cards;
11: increasing a quantity of some obtained cards; and
12: increasing a card-swapping opportunity, and so on. Details are not described one by one.

For example, an effect of a "Duo" card is: randomly obtaining two identical hero cards. An effect of a "Talent Search" card is: choosing 1 out of 3 hero cards with the highest quality available at a current chess player level. An effect of a "Copy" a card is: randomly obtaining one card having a same name as one deployed hero. An effect of a "Five Grains Harvest" card is: immediately replenishing cards until the chess player has five cards in hand. An effect of a "Random Enhancement" card is: randomly increasing a level of one deployed hero by 5. An effect of a card "One More" is: drawing one card and obtaining one additional free card-swapping opportunity in this round. An effect of a "Prayer" card is: reducing an energy value consumed by all cards by 1. An effect of an "Extra Cards" is: drawing two cards.

In some examples, the effect card may be classified into at least one of a universal effect card, a piece-type effect card, and a faction effect card. The universal effect card is an effect card whose card attribute is unrelated to a piece type/faction. The card attribute includes at least one of an obtaining condition, a use condition, a card effect, and an effect range. The piece-type effect card is an effect card whose card attribute is related to a piece type, for example, a card that can only be obtained or used or whose effect can only be enjoyed by a piece of a reference piece type. The faction effect card is an effect card whose card attribute is related to a faction, for example, a card that can only be obtained or used or whose effect can only be enjoyed by a piece that belongs to a reference piece faction. The reference piece type may include one or more piece types, and the reference faction may include one or more factions.

For example, an effect card of a piece type may be obtained at a specific probability only in a case that a piece card of the piece type is played.

### Equipment card

The equipment card is a card configured to equip at least one piece of this party with equipment. FIG. 6 is a schematic card diagram of an equipment card according to an example of this application. The equipment card displays at least one piece of the following information: an equipment icon 41, an equipment name 42, an energy value 43 consumed when the card is played, and an equipment description 44 of the equipment card.

The equipment icon 41 may be an icon configured to represent an equipment image or an equipment effect. In FIG. 6, a description is made by using an example in which the icon has a circular border. The equipment name 42 is a name of the equipment card or a name of the equipment. Different equipment may enhance a combat capability of the piece of this party in various dimensions such as a hit point, armor, defense, and mana, or weaken a combat capability of the piece of the opposing party.

The energy value 43 refers to an energy value consumed when the equipment card is played. The energy value is a non-negative number. For example, the energy value may be an integer or a decimal. Energy is a resource in the round-based board game. In an example, different amounts of energy need to be consumed when equipment cards of different qualities are played. For example, when five equipment cards of different qualities are played, 0, 1, 2, 3, and 4 energy points need to be consumed respectively. In an example, energy values consumed by different equipment cards may be regularly or irregularly adjusted based on actual game conditions, to maintain fairness and appeal of the game. For example, energy values consumed by different equipment cards may be regularly or irregularly adjusted based on game balance.

The equipment description 44 of the equipment card is configured for describing an effect of the equipment after the equipment is equipped.

### Chess player card

The chess player card is a card obtained through a chess player skill of a chess player virtual character. The chess player card may be a card triggered and obtained by a passive skill of the chess player virtual character. The passive skill refers to a skill that does not need to be triggered by an active operation of a player object, but continuously takes effect or automatically takes effect when a particular condition is satisfied. For example, the chess player card may be a card that can be obtained by only a specific chess player virtual character, a card that can be used by only a specific chess player virtual character, a card exclusive to only a specific chess player virtual character, or the like. This is not limited in the examples of this application.

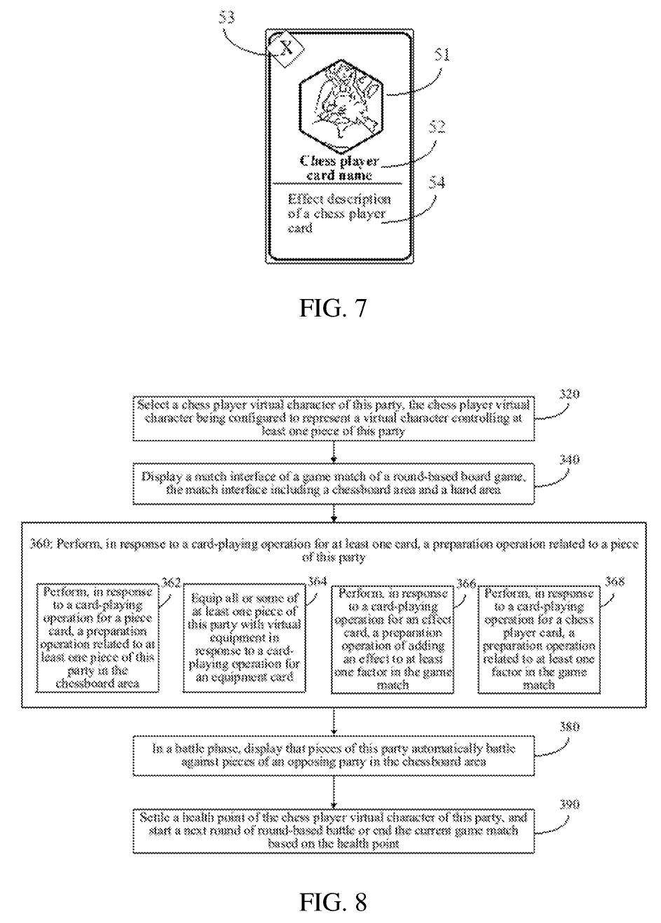

FIG. 7 is a schematic card diagram of a chess player card according to an example of this application. The chess player card displays at least one piece of the following information: a card icon 51, a chess player card name 52, an energy value 53 consumed when the card is played, and an effect description 54 of the chess player card.

The card icon 51 may be an icon configured to represent a card effect. In FIG. 7, a description is made by using an example in which the icon has a hexagonal border. The chess player card name 52 is a name of the chess player card or a name of the effect.

The energy value 53 refers to an energy value consumed when the chess player card is played. The energy value is a non-negative number. For example, the energy value may be an integer or a decimal. Energy is a resource in the round-based board game. In an example, different amounts of energy need to be consumed when chess player cards of different qualities are played. For example, when five chess player cards of different qualities are played, 0, 1, 2, 3, and 4 energy points need to be consumed respectively. In an example, energy values consumed by different chess player cards may be regularly or irregularly adjusted based on actual game conditions, to maintain fairness and appeal of the game. For example, energy values consumed by different chess player cards may be regularly or irregularly adjusted based on game balance.

The effect description 54 of the chess player card is configured for describing an effect added after use of the chess player card. The effect added after use of the chess player card may be the same as or similar to the effect of the piece card, the equipment card, or the effect card, or exceeds an effect range of the piece card, the equipment card, or the effect card. In a possible design of different examples, the effect added after use of the chess player card may be designed to be any form of effect such as summoning a piece, upgrading a piece, adding equipment, adding a buff effect, reducing energy consumption, or affecting a card obtaining process. The effect added after use of the chess player card may be designed to affect any process or details in the game match. This is not limited in the examples of this application.

It can be known based on the introduction of the foregoing four types of cards that: different types of cards have different functions. The shop may be eliminated from conventional auto chess through the piece card based on playstyle characteristics of the card, the effect button or control may be eliminated from conventional auto chess through the effect card, the creeping round may be eliminated from conventional auto chess through the equipment card, and gameplay characteristics related to the chess player may be incorporated through the chess player card. Based on different types of cards, different mechanisms in the round-based board game are simplified into a process of playing cards. This not only can reduce user interface elements that need to be displayed on a battle interface, but also can reduce operational difficulty for a player object of this party to improve human-computer interaction efficiency of the player object of this party.

In addition, compared with a three-dimensional piece that cannot carry text information well because the text information that can be carried by the three-dimensional piece is limited, the two-dimensional card has a card characteristic that enables the two-dimensional card to naturally carry more text information and icon information. Therefore, compared with the conventional three-dimensional piece in the preparation phase, the two-dimensional card can increase an amount of information carried in a limited display range on a small-screen terminal and improve information transmission efficiency.

The foregoing cards may be played in the preparation phase, and some cards may alternatively be played in the battle phase, such as some equipment cards, and an effect card for allowing a player object to immediately draw two more cards.

### Card obtaining manner

The player object of this party obtains at least one card in a case that an obtaining condition is satisfied. The obtaining condition includes at least one of the following:

Obtaining condition 1: A new round of round-based battle starts. Several cards are obtained each time a new round of round-based battle starts. For example, four cards are drawn in a first round of round-based battle, and two cards are drawn in a subsequent round of round-based battle.

Obtaining condition 2: A preset piece card is used. The preset piece card refers to a piece card having an additional skill such as drawing or adding or copying a card. For example, when a piece card having the same name as a deployed piece is played, one effect card is additionally obtained. In some examples, the additional skill may alternatively be referred to as an additional effect.

Obtaining condition 3: A preset effect card is used. The preset effect card refers to an effect card having an effect such as drawing or adding or copying a card.

Obtaining condition 4: A preset chess player card is used. The preset chess player card refers to a chess player card having an effect such as drawing or adding or copying a card.

Obtaining condition 5: A resource owned by this party is consumed to exchange for a card. For example, energy is consumed to draw or exchange for a card.

Obtaining condition 6: A chess player level of a chess player virtual character is upgraded. After the chess player level is upgraded, a card of higher quality or a larger quantity of cards may be unlocked and obtained.

Obtaining condition 7: A card pool level is upgraded. After the card pool level is upgraded, a card of higher quality or a larger quantity of cards may be unlocked and obtained.

Obtaining condition 8: A card purchase operation is performed.

Obtaining condition 9: A preset chess player skill is triggered. The preset chess player skill refers to a passive skill having an effect such as drawing or adding or copying a card. For example, one chess player card may be drawn every 2 rounds; or one chess player card may be drawn each time 3 cards are played.

The foregoing obtaining conditions may be combined. For example, some cards can only be obtained by using the preset chess player card after the chess player level reaches level 2. Obtaining conditions of different types of cards may be completely different or completely the same, or some conditions may be the same and some conditions may be different.

FIG. 8 is a flowchart of a match interaction method for a round-based board game according to an example of this application. The method may be performed by a computer device, and the computer device may include a terminal or a server. In this example, a description is made by using an example in which the method is performed by a terminal. The method includes operation 320 to operation 390 below.

### Chess player selection phase

Operation 320: Select a chess player virtual character of this party, the chess player virtual character being configured to represent a virtual character controlling at least one piece of this party.

Before each game match starts, a player object of this party selects a desired chess player virtual character. Different chess player virtual characters have different chess player skills. The chess player skill is typically related to an obtained chess player card, or may alternatively be related to another game factor.

In some examples, different chess player skills have some respective passive trigger mechanisms that enable the player object of this party to obtain some cards with special effects. For example, a chess player skill effect of a player is: obtaining one treasure chess player card each time 3 piece cards are played, and an effect of the treasure chess player card is: increasing a level of a designated piece of this party in a chessboard area by 2 by consuming 1 energy point.

In some examples, a chess player selection interface is displayed before a game match starts. The chess player selection interface displays chess player virtual characters selected by player objects engaging in the game match. In an example, the chess player virtual character selected by the player object of this party is prominently displayed on the chess player selection interface, and chess player virtual characters selected by other player objects are normally displayed on the chess player selection interface. Prominent display and normal display are two different display modes. For example, the prominent display mode may include, but is not limited to, at least one of controlling a chess player virtual character to be in a standing posture, enlarged display, centered display, foreground display, blinking display, highlighted display, and bold border display. The normal display mode may include, but is not limited to, at least one of controlling a chess player virtual character to be in a sitting posture, normal size display, display on both sides, background display, non-blinking display, non-highlighted display, or normal border thickness display.

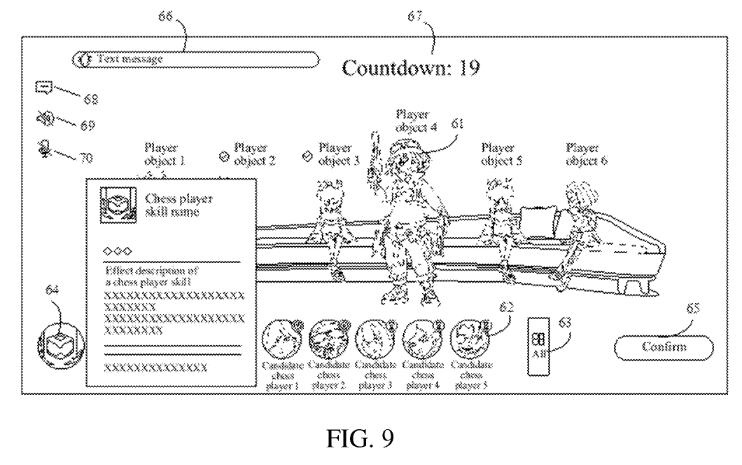

For example, as shown in FIG. 9, before the game match starts, the chess player selection interface is displayed. The chess player selection interface displays chess player virtual characters selected by 6 player objects. In an example, a chess player virtual character 61 selected by the player object of this party is prominently displayed. An example in which the player object of this party is a player object 4 is used. A chess player virtual character selected by the player object 4 is prominently displayed in a standing posture, enlarged, and centered in the foreground, and a chess player virtual character selected by another player object is normally displayed in a sitting posture, normal size, and distributed on both sides.

In some examples, a plurality of candidate chess player virtual characters are displayed on the chess player selection interface, and the chess player virtual character selected by the player object is a chess player virtual character among the plurality of candidate chess player virtual characters. In an example, all candidate chess player virtual characters may be directly displayed on the chess player selection interface. In an example, some candidate chess player virtual characters may alternatively be displayed on the chess player selection interface, and other chess player virtual characters are displayed in response to a slide operation. In an example, the chess player selection interface may further display some candidate chess player virtual characters and a view control, and all candidate chess player virtual characters are displayed in response to a trigger operation for the view control. The view control may be a button, a triggerable icon, or the like. For example, the view control may be marked with the word "All", to prompt a player object that the player object can view all candidate chess player virtual characters by triggering the view control. The trigger operation for the view control may be a click/tap operation or another operation. This is not limited in the examples of this application.

For example, referring to FIG. 9, several candidate chess player virtual characters 62, such as a candidate chess player 1 to a candidate chess player 5, are displayed on the chess player selection interface. By sliding left or right, other candidate chess player virtual characters may be viewed, or by clicking/tapping a "All" button 63, all candidate chess player virtual characters may be viewed.

In some examples, a chess player skill control is further displayed on the chess player selection interface. Description information of a chess player skill of a currently selected chess player virtual character is displayed in response to a trigger operation for the chess player skill control. In an example, the chess player skill control may be a button, a triggerable icon, or the like. The trigger operation for the chess player skill control may be a click/tap operation or another operation. The description information of the chess player skill may include, but is not limited to, a name of the chess player skill, an effect description, and the like. In an example, the description information of the chess player skill of the currently selected chess player virtual character may be displayed in any area of the chess player selection interface, or the description information of the chess player skill of the currently selected chess player virtual character may be displayed in a pop-up window on a peripheral side of the chess player skill control. In an example, the peripheral side of the chess player skill control may include, but is not limited to, a right side, a left side, and the like of the chess player skill control.

For example, referring to FIG. 9, a chess player skill button 64 is further displayed on the chess player selection interface. A name and an effect description of the chess player skill of the currently selected chess player virtual character may be viewed in a pop-up window on the right side in response to the chess player skill button 64 being clicked/tapped.

In an example, at least one of a message transmitted by another player object, a countdown for selecting a chess player or entering a match, a transmit control for a text message, an off/on control for a speaker, an off/on control for a microphone, and a confirm control may further be displayed on the chess player selection interface. Different content is displayed in different areas of the chess player selection interface. The control may be a button, a triggerable icon, or the like. For example, after confirming the selected chess player virtual character, the player object of this party may enable the selected chess player virtual character to enter a preparation state by triggering the confirm control. In response to a trigger operation for the confirm control, the chess player virtual character selected by the player object of this party is controlled to enter the preparation state. The preparation state refers to a state of preparing to engage in a game match. The trigger operation for the confirm control may be a click/tap operation or another operation.

For example, referring to FIG. 9, a message 66 transmitted by another player object and a countdown 67 for selecting a chess player or entering a match are displayed at the top of the chess player selection interface. A transmit button 68 for a text message, an off/on button 69 for a speaker, and an off/on button 70 for a microphone are displayed on the left side of the chess player selection interface. After confirming the selected chess player virtual character, the player object of this party may click/tap a "Confirm" button 65 (a confirm control) to enter the preparation state.

n player objects engaging in a game match are paired for a round-based battle. Each round includes a preparation phase and a battle phase, and n is an integer greater than or equal to 2.

### Preparation phase of each round

Operation 340: Display a match interface of a game match of a round-based board game, the match interface including a chessboard area and a hand area.

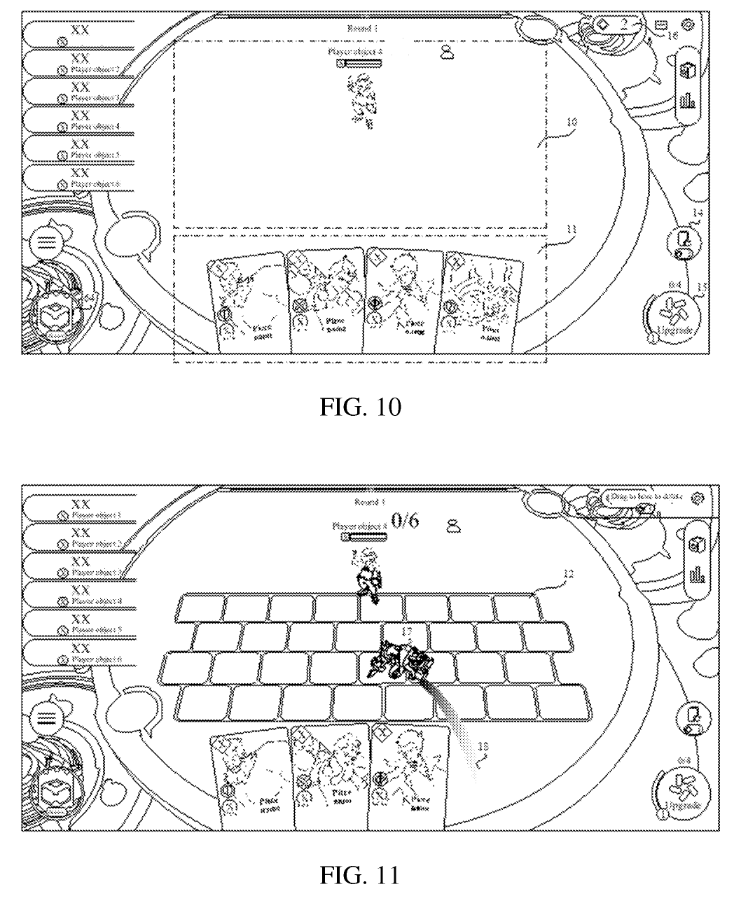

With reference to FIG. 10, a chessboard area 10 is configured to accommodate at least one piece of this party and at least one piece of an opposing party. In an example, an upper half of the chessboard area 10 is configured to accommodate the at least one piece of the opposing party, and a lower half of the chessboard area 10 is configured to accommodate the at least one piece of this party. The hand area 11 is configured to display at least one card held by the player object of this party. In an initial state or in some cases (for example, all cards in a current round are played), a quantity of cards displayed in the hand area 11 is 0.

In an example, at least one of attribute information of n player objects engaging in a current game match, a chess player skill control, a card swap control, an upgrade control, and an energy control may further be displayed on the match interface. Different content is displayed in different areas of the match interface. The attribute information of the player object is configured for describing an attribute of the player object. In an example, the attribute information includes at least one of a nickname of a player, an avatar of the player, a hit point of the player, and a chess player level of the player. The chess player skill control, the card swap control, the upgrade control, and the energy control may be in the form of buttons, triggerable icons, or the like. The chess player skill control is configured to view the description information of the chess player skill of the chess player virtual character. The card swap control is configured to swap one or more cards in the hand area. The upgrade control is configured to upgrade a level of the chess player virtual character. The energy control is configured to display an energy value possessed by the player object of this party.

In an example, as shown in FIG. 10, the attribute information of the n player objects engaging in the current game match is further displayed at an upper left corner of the match interface. The attribute information includes at least one of a nickname of a player, an avatar of the player, a hit point of the player, and a chess player level of the player. A chess player skill button 64 is displayed at a lower left corner of the match interface. A card swap button 14 and an upgrade button 15 are further displayed at a lower right corner of the match interface. The card swap button 14 is configured to swap one or more cards in the hand area 11. The upgrade button 15 is configured to upgrade a level of a chess player virtual character, to unlock a higher-level card and capability and obtain equipment.

In an example, as shown in FIG. 10, an energy control 16 is further displayed at an upper right corner of the match interface. The energy control 16 is configured to display an energy value possessed by the player object of this party. Energy is a game resource, and may be required in each phase of an entire game match. For example, energy is required for playing a card, energy is required for swapping a card, and energy is required for upgrading a level of a chess player virtual character.

Operation 360: Perform, in response to a card-playing operation for at least one card, a preparation operation related to a piece of this party.

A card type includes at least one of a piece card, an equipment card, an effect card, and a chess player card. Through card-playing operations for cards of different card types, the player object of this party may perform preparation operations having different functions. This operation includes at least one of the following operations:

Operation 362: Perform, in response to a card-playing operation for a piece card, a preparation operation related to at least one piece of this party in the chessboard area.

Operation 364: Equip all or some of at least one piece of this party with virtual equipment in response to a card-playing operation for an equipment card.

Operation 366: Perform, in response to a card-playing operation for an effect card, a preparation operation of adding an effect to at least one factor in the game match.

Operation 368: Perform, in response to a card-playing operation for a chess player card, a preparation operation related to at least one factor in the game match.

Because a battle situation of each round of round-based battle is different, player objects have different cards in hand, and the player objects have different card-playing habits, a quantity of times and an order in which operation 362, operation 364, operation 366, and operation 368 are performed in each round of round-based battle may vary. This is not limited in this example.

Regarding operation 362 (the piece card): In some examples, the cards located in the hand area includes a first piece card. A first piece of this party is added to the chessboard area in response to a card-playing operation for the first piece card. The first piece of this party is a piece corresponding to the first piece card. In some examples, the first piece of this party is a piece not summoned to the chessboard area.

In a case that the first piece of this party does not exist in the chessboard area, the first piece of this party is added to the chessboard area in response to the card-playing operation for the first piece card.

In some examples, at least two candidate squares and a first indication element corresponding to a first piece card are displayed in the chessboard area in response to the card-playing operation for the first piece card. The first indication element includes at least one of a zoomed-out first piece card, the first piece of this party, and a first indication arrow. The first piece of this party is added to a first candidate square in response to a drag operation of dragging the first indication element to the first candidate square. The first candidate square is one of the at least two candidate squares. In a case that the first indication element includes the first indication arrow, a starting point of the first indication arrow is a position of the first piece card before the first piece card is played, and an end point of the first indication arrow is a real-time position of the drag operation.

The at least two candidate squares may be all candidate squares or candidate squares only belonging to this party. The at least two candidate squares may be always displayed, or may be displayed only when a card-playing operation is recognized.

An example in which the first piece card is the 4th card in FIG. 10 is used. With reference to FIG. 11, a first piece 17 of this party and a first indication arrow 18 are displayed in response to a drag operation for the first piece card. The first piece 17 of this party is a three-dimensional piece, and slides following a real-time position of the drag operation. A starting point of the first indication arrow 18 is a position of the first piece card before the first piece card is played, and an end point of the first indication arrow 18 is the real-time position of the drag operation. In a case that the drag operation is released over the first candidate square, the first piece 17 of this party is summoned to the first candidate square.

It can be known based on FIG. 11 that, in the interaction method, a piece preparation area is eliminated, and the hand area has both the piece obtaining function and the preparation function. In this way, a plurality of functions are implemented in one display area, to improve human-computer interaction efficiency.

In some examples, the cards located in the hand area includes a second piece card. A piece level of a second piece of this party is upgraded in the chessboard area in response to a card-playing operation for the second piece card and the second piece of this party existing in the chessboard area. The second piece of this party is a piece corresponding to the second piece card.

The card-playing operation for the second piece card may alternatively be a drag operation. However, because the second piece of this party has already existed in the chessboard area, the drag operation may be released at any position in the chessboard area to complete the drag operation, and the second piece card may take effect without being precisely dragged onto the second piece of this party by the player object of this party.

Regarding operation 364 (the equipment card): In some examples, the cards located in the hand area includes the equipment card. A second indication element corresponding to the equipment card is displayed in response to a card-playing operation for the equipment card. The second indication element includes at least one of a zoomed-out equipment card, virtual equipment corresponding to the equipment card, and a second indication arrow. The second piece of this party is equipped with the virtual equipment in response to a drag operation of dragging the second indication element to the second piece of this party. The second piece of this party is a piece of this party that has already existed in the chessboard area. In a case that the second indication element includes the second indication arrow, a starting point of the second indication arrow is a position of the equipment card before use, and an end point of the second indication arrow is a real-time position of the drag operation. Different equipment cards may correspond to different virtual equipment, or may correspond to the same virtual equipment.

Regarding operation 366 (the effect card): In some examples, the cards located in the hand area includes the effect card. In response to a card-playing operation for the effect card, an effect is added to at least one piece of this party, and/or an effect is added to a card obtaining process.

The effect cards are classified into two major types according to action objects: type I: an effect card of this type adds an effect to a piece of this party in the chessboard area; and type II: an effect card of this type adds an effect to a card obtaining process.

An effect is added to at least one piece of this party in response to a card-playing operation for the effect card of type I, for example, adding a buff exclusive to the piece type, and adding a combined buff when at least two pieces of a same faction are deployed at the same time.

An effect is added to a card obtaining process in response to a card-playing operation for the effect card of type II, for example, drawing two identical piece cards consecutively.

Regarding operation 368 (the chess player card): At least one of the following preparation operations is performed in response to a card-playing operation for the chess player card: adding pieces of this party, reducing pieces of this party, upgrading a piece of this party, adding an effect to a piece of this party, equipping a piece of this party with equipment, an operation related to card obtaining, performing an operation related to card selling, an operation related to card exchanging, an operation related to a subsequent round, and an operation related to a health point of the player object of this party.

The chess player card has a special function, which may be any one of functions of the piece card, the equipment card, and the effect card, or may be a function related to the card obtaining process, or may be a function related to a health point of the chess player. In different design implementations, a function that can affect a factor in a game match may be designed as a function of the chess player card. This is not limited in the examples of this application.

In the preparation phase, the player object of this party may further use at least one of a card-swapping function, a card-deleting function, and a chess player level upgrade function.

### Card-swapping function

In the preparation phase, the player object of this party may further swap one or more cards in the hand area. One or more cards are swapped by clicking/tapping a card swap button. Energy is required for card swapping. For example, card swapping can only performed once in each round, and a plurality of cards can be swapped each time. Regardless of how many cards are swapped, 1 energy point is consumed.

### Card-deleting function

In a process of playing cards, a card may be deleted or sold by dragging the card to a reference position. The reference position may be set according to experience, or may be flexibly adjusted according to game rules of the round-based board game. This is not limited in the examples of this application. A resource consumed by a deleted card may be not recovered, or may be partially recovered. Alternatively, a fixed amount of energy is recovered. For example, 1 energy point is gained each time one card is deleted.

### Chess player level upgrade function

The player object of this party obtains an amount of energy in each round. Energy not used in a current round may be accumulated to a next round, and a chess player level may be upgraded by using energy. A higher chess player level indicates higher quality of a card that can be drawn in each round, and meanwhile, some new capabilities, such as talents and purchasable equipment, are unlocked. In an example, quality identifiers may be displayed on an upgrade button 15 in FIG. 10 in different colors. As the chess player level is upgraded, a quality identifier corresponding to a current chess player level is lightened, to indicate quality of a card that can be obtained by the player object at the current chess player level. The quality identifier may be, for example, a small rounded rectangle shown in FIG. 12, or may be in another shape or form.

For example, the player object of this party at a chess player level of level 1/2/3/4/5 unlocks a card of quality 1/2/3/4/5.

### Battle phase of each round

Operation 380: In a battle phase, display that pieces of this party automatically battle against pieces of an opposing party in the chessboard area.

A process in which the pieces of this party and the pieces of the opposing party automatically engage in the battle in the chessboard area does not require manual control by the player object of this party. The client or the server automatically controls, based on factors such as square positions of the pieces of both parties on the chessboard, attributes of the pieces, levels of the pieces, skills of the pieces, and enhanced attributes of combinations of the pieces, the pieces to engage in the battle until all pieces of one party are defeated.

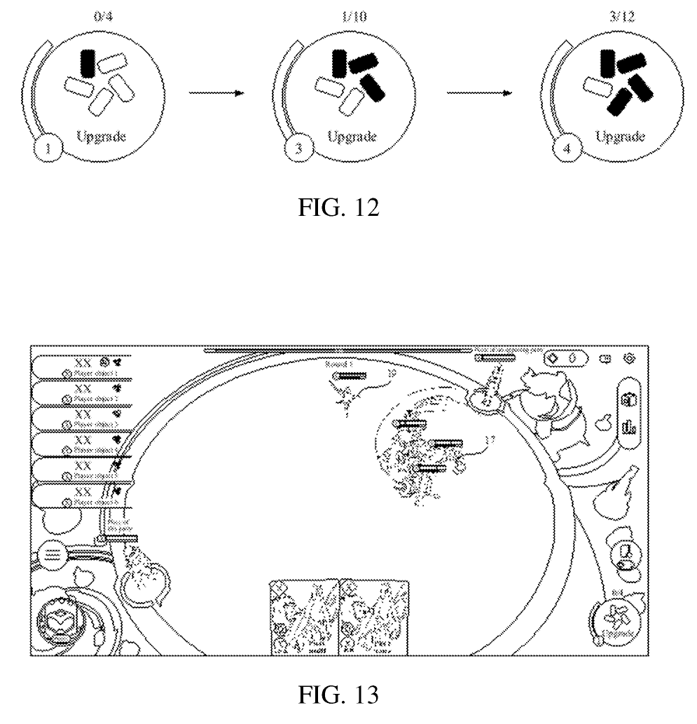

FIG. 13 is a schematic diagram of an automatic battle between a piece 17 of this party and a piece 19 of an opposing party in a chessboard area. Actions, such as movement, skill release, and functions, of the pieces of both parties during the battle do not require manual control by the players.

### Battle settlement phase

Operation 390: Settle a health point of the chess player virtual character of this party, and start a next round of round-based battle or end the current game match based on the health point.

Both the player object of this party and the player object of the opposing party have health points. After this round ends, the health point of the player object of the loser is reduced by a specific amount. The specific amount may be determined based on a quantity of remaining pieces of the winner, or may be a fixed value. This is not limited in this example.

When the health point is reduced to zero, the player object is eliminated from the current game match.

When the health point is not reduced to zero, a next round of round-based battle starts in the current game match, the player object continue to battle against one player object among n player objects until the player object is eliminated, or the player object, as the last remaining player object who has not been eliminated, wins the game match.

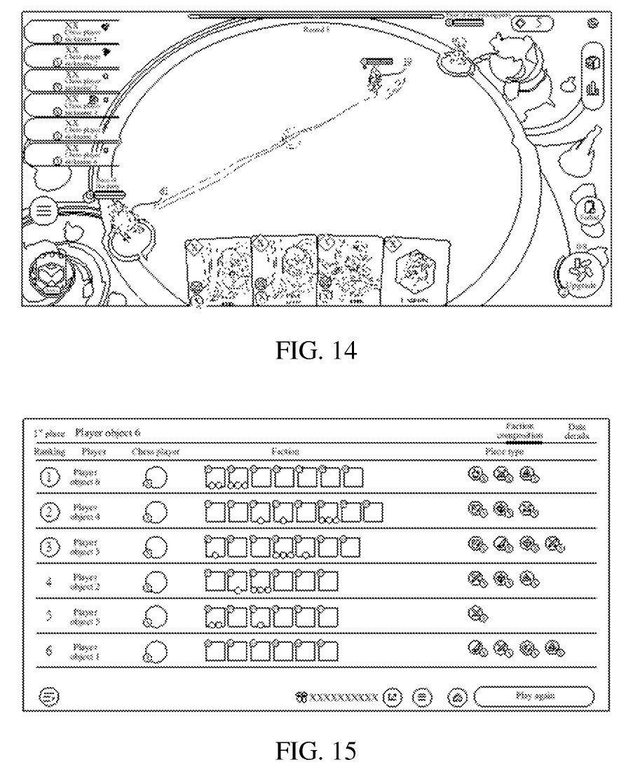

In some examples, settled damage is determined according to the quantity of remaining deployed pieces of the winner. FIG. 14 shows a special animation effect of settling a health point of a chess player virtual character 61 of this party when this party is the loser and the opposing party still has one piece 19. A health bar may be displayed above the head of the chess player virtual character 61.

For example, referring to FIG. 15, settlement information of the current game match is displayed on a settlement interface. The settlement information includes information such as rankings of players, a chess player used by each player, faction compositions, and piece types.

In conclusion, in the method according to this example, by introducing the "card" mechanism into the round-based board game, a plurality of preparation operations are simplified and integrated in the process of playing a plurality of cards. The concept of a shop is eliminated, and the player no longer needs to perform a plurality of interactions between various sub-areas, such as the shop, the piece preparation area, and the piece battle area, of the conventional battle interface, to obtain and upgrade pieces and engage in the battle. The conventional process in which a user needs to actively select and purchase pieces is changed into a process of passively receiving dealt cards. The game system completes some tedious operations instead of the user, and the user only needs to perform the card-playing operation basically the same as that in a card game, to complete a plurality of preparation operations. This improves human-computer interaction efficiency, shortens match duration of a game match, shortens service duration of the server for the game match, and saves resources of the server.

In particular, when the round-based board game is operated on a small-screen terminal such as a mobile phone or a tablet, the player can complete a plurality of preparation operations based on limited operations in the hand area. Compared with conventional auto chess, the method according to this example can significantly enhance human-computer interaction efficiency.

In the method according to this example, the shop may be eliminated from conventional auto chess through the piece card based on playstyle characteristics of the card, an original tedious process in which a user needs to purchase desired pieces from dozens of available pieces in the shop is changed into a process in which the game system automatically deals cards to the player, and the user does not need to manually select cards. This reduces a quantity of interactions required for obtaining pieces by the user and an amount of information needs to be processed by the user.

In the method according to this example, the effect button or control may be eliminated from conventional auto chess through the effect card, the creeping round may be eliminated from conventional auto chess through the equipment card, and gameplay characteristics related to the chess player may be incorporated through the chess player card. Based on different types of cards, different mechanisms in the round-based board game are simplified into a process of playing cards. This not only can reduce user interface elements that need to be displayed on a battle interface to reduce time for actively searching for related function entries by the user, but also can reduce operational difficulty for a player object of this party to improve human-computer interaction efficiency of the player object of this party.

With reference to the foregoing introduction of the round-based board game and the foregoing description of the implementation environment, a match playing method for a round-based board game according to the examples of this application is described. The method may be performed by a computer device, and the computer device may include a terminal or a server. A description is made by using an example in which the method is performed by the terminal shown in FIG. 1 or a client running on the terminal. The client running on the terminal is a client of an application program, and the application program is a program of a round-based board game.

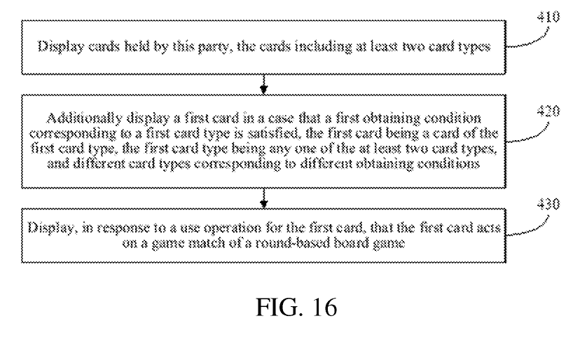

FIG. 16 is a flowchart of a match playing method for a round-based board game according to an example of this application. The method may be performed by any terminal in FIG. 1 or a client running on any terminal. The client is a client of a round-based board game. The method includes operation 410 to operation 430 below.

Operation 410: Display cards held by this party, the cards including at least two card types.

For example, the method is performed by a terminal, or the method is performed by a client on a terminal. The terminal is controlled by a first user/first player. A first user account is logged into on the client. The cards held by this party refer to cards held by the first user account, or the cards held by this party refer to cards held by a first chess player (a first chess player virtual character) played by the first user account in a game match of a round-based board game.

In some examples, the displaying the cards held by this party includes: displaying a match interface of a game match of a round-based board game. The match interface includes a hand area, and the hand area is configured to present the cards held by this party.

In an example, the match interface is an interface in a first game match, and the first game match is a game match that the first user account engages in. Any interface in the first game match may be referred to as a match interface. For example, in response to receiving an operation of starting a game match, the client/server matches an opponent account for the first user account. After successful matching, it is displayed that the first user account and the matched opponent account jointly engage in a first game match, and a match interface of the first game match is displayed. In an example, a quantity of opponent accounts may be set according to experience, or may be flexibly adjusted according to game rules of the round-based board game. This is not limited in the examples of this application. For example, the quantity of opponent accounts may be 5 or 7.

In an example, the match interface of the game match of the round-based board game is displayed. The match interface includes a chessboard area and a hand area. Alternatively, a match interface of a preparation phase of the game match of the round-based board game is displayed. The match interface includes a chessboard area and a hand area. For example, as shown in FIG. 3, the match interface includes the chessboard area 10 and the hand area 11.

The chessboard area is configured to accommodate pieces engaging in a game battle. The hand area is configured to accommodate or display the cards held by the first user account. Alternatively, if the first user account plays the first chess player (the first chess player virtual character) in the first game match, the hand area is configured to accommodate the cards held by the first chess player.

For example, the hand area in the examples of this application is a hand area of this party, namely, a hand area of the first user account/the first chess player. In addition, the match interface displays only one hand area (the hand area of this party). In the examples of this application, the cards displayed in the hand area refer to the cards held by this party, namely, the cards held by the first user account/the first chess player.

For example, any quantity of cards may be displayed in the hand area, or no card exists in the hand area. For example, a quantity of cards that can be displayed in the hand area has an upper limit, that is, a quantity of cards that can be held by a chess player has an upper limit. The upper limit may be set according to experience, or may be flexibly adjusted according to game rules of the round-based board game. This is not limited in the examples of this application. For example, the upper limit is 10. For example, the chess player may increase the upper limit by upgrading a chess player level or by using an effect card or a chess player card. For example, the quantity of cards that can be displayed in the hand area is increased from 10 to 12 after a first effect card is used.

In some examples, two hand areas may further be displayed on the match interface. One hand area is a hand area of this party, and the other hand area is an opponent hand area. The hand area of this party is configured to display the cards held by this party, and front faces of the cards are displayed in the hand area of this party (the front face of the card displays specific information about the card, such as a card name, a card type, and a detailed card introduction). The opponent hand area is configured to display cards held by an opposing party, and back faces of the cards are displayed in the opponent hand area (the back face of the card does not display specific information about the card). A user can view a quantity of cards held by the opposing party through the hand area of the opposing party, but cannot view specific content of the cards. The opponent hand area is configured to display cards held by an opponent account/an opponent chess player in a current game round. Alternatively, at least two opponent hand areas may be displayed on the match interface. For example, opponent hand areas corresponding to all opponent chess players engaging in a current game match are displayed. The opponent refers to an account/a chess player who battles against this party. In some examples, the opponent may alternatively be referred to as an opposite party, an opposing party, or the like; and this party may alternatively be referred to as a friendly party.

The round-based board game includes a preparation phase and a battle phase. In the preparation phase, a player may adjust pieces of a friendly party in the chessboard area, for example, adds a new piece to the chessboard area by using a card in the hand area, or adds a buff effect to a piece in the chessboard area by playing a card in the hand area, or obtains energy by selling a piece in the chessboard area. In an example, in the battle phase, the player cannot adjust the pieces in the chessboard area, and the pieces in the chessboard area automatically battle against pieces of an opposing party.

In an example, in the preparation phase, the chessboard area is divided into a chessboard area of the friendly party and a chessboard area of the opposing party, and the player may adjust the pieces in the chessboard area of the friendly party in the preparation phase. In the battle phase, the chessboard area of the friendly party and the chessboard area of the opposing party form a complete battle field (a complete chessboard area), and the pieces of both parties battle against each other in the complete battle field.

The chessboard area is configured to accommodate pieces engaging in a battle, and when the battle phase starts, the pieces located in the chessboard area battles against the pieces of the opposing party. In the preparation phase, the player may adjust the pieces in the chessboard area. After the preparation phase ends and the battle phase starts, the chessboard area is locked to be in a non-adjustable state, and the pieces currently located in the chessboard area automatically battles with the pieces of the opposing party. The preparation phase starts again after the battle phase ends. Because types, the quantity, deployment positions, and the like of the pieces in the chessboard area all affect a battle result, in the preparation phase, the player needs to quickly and properly adjust the positions of the pieces for a next battle.

The usage timing of a card may be restricted by using at least one of the following methods:

Method 1: Because the pieces cannot be adjusted in the battle phase, the player cannot use a card in the battle phase, that is, the card cannot be used in the battle phase.

Method 2: Although the pieces cannot be adjusted in the battle phase, the player can still use a card in the battle phase. When this method is used, a card effect that cannot be immediately applied to the battle phase may be delayed to take effect after the battle phase ends. The card may be used in the battle phase, but the card effect of the card after use is delayed to take effect in a next preparation phase (or delayed to take effect after the battle phase ends). For example, the player uses a first piece card in the battle phase, and after the first piece card is used, a first piece needs to be added to the chessboard area. However, because the quantity of pieces in the chessboard area cannot be increased currently in the battle phase, a use instruction for the first piece card is temporarily stored. After the battle phase ends, the use instruction for the first piece card is read and processed when the preparation phase starts, and the first piece is additionally displayed in the chessboard area.

Method 3: A card may be used in the battle phase, and a card effect of the card immediately takes effect after use. For example, the player uses a first effect card in the battle phase, and a card effect of the first effect card after use is immediately refreshing skill cooldown time of all pieces of the friendly party in the chessboard area. In this case, when a use instruction for the first effect card is received, the skill cooldown time of all pieces of the friendly party in the chessboard area is refreshed.

For example, for different types of cards, the usage timing of the card may be restricted by using the foregoing different methods.

For example, a piece card cannot be used in the battle phase, or the piece card can be used only in the preparation phase. Alternatively, the piece card is allowed to be used in the battle phase, but a card effect is delayed to take effect in a next preparation phase.

For another example, an effect card cannot be used in the battle phase, or the effect card can be used only in the preparation phase. Alternatively, the effect card is allowed to be used in the battle phase, but a card effect is delayed to take effect in a next preparation phase. Alternatively, the effect card is allowed to be used in the battle phase, and the card effect immediately takes effect. Alternatively, effect cards are classified into an in-battle effect card and a pre-battle effect card according to the usage timing of different effect cards. The in-battle effect card is an effect card that is allowed to be used in the battle phase and that immediately takes effect, and the pre-battle effect card is an effect card that can be used only before the battle phase. Therefore, the in-battle effect card may be allowed to be used in the battle phase, and a card effect immediately takes effect. However, the pre-battle effect card is not allowed to be used in the battle phase, or the pre-battle effect card is allowed to be used in the battle phase, but a card effect is delayed to take effect in a next preparation phase.

For another example, an equipment card cannot be used in the battle phase, or the equipment card can be used only in the preparation phase. Alternatively, the equipment card is allowed to be used in the battle phase, but the card effect is delayed to take effect in a next preparation phase.

For another example, a chess player card cannot be used in the battle phase, or the chess player card can be used only in the preparation phase. Alternatively, the chess player card is allowed to be used in the battle phase, but the chess player card is delayed to take effect in a next preparation phase. Alternatively, the chess player card is allowed to be used in the battle phase, and the chess player card immediately takes effect. Alternatively, chess player cards are classified into an in-battle chess player card and a pre-battle chess player card according to the usage timing of different chess player cards. The in-battle chess player card is a chess player card that is allowed to be used in the battle phase and that immediately takes effect, and the pre-battle chess player card is a chess player card that can be used only before the battle phase. Therefore, the in-battle chess player card may be allowed to be used in the battle phase, and a card effect immediately takes effect. However, the pre-battle chess player card is not allowed to be used in the battle phase, or the pre-battle chess player card is allowed to be used in the battle phase, but a card effect is delayed to take effect in a next preparation phase.

Operation 420: Additionally display a first card in a case that a first obtaining condition corresponding to a first card type is satisfied, the first card being a card of the first card type, the first card type being any one of the at least two card types, and different card types corresponding to different obtaining conditions.

For example, in a case that the first obtaining condition corresponding to the first card type is satisfied, a card obtaining animation is displayed, and after playback of the card obtaining animation is completed, the first card is additionally displayed. Based on this, displaying the card obtaining animation can intuitively prompt the player that a new card is about to be additionally displayed. This helps enhance visual experience of the player, improves interaction experience of the player, and improves human-computer interaction efficiency.

In an example, the first card is additionally displayed in the hand area, and the hand area refers to an area, configured to present the cards held by this party, of the match interface of the game match.

For example, the at least two card types include at least two of the following card types: a piece card, an effect card, an equipment card, and a chess player card. The first card type may be any one of the card types.

The piece card is configured to summon a piece or upgrade a piece. For example, FIG. 4 shows one type of piece card. Different piece cards have different piece names. The player may summon a piece corresponding to a piece card in the chessboard area by using the piece card (a piece name of the piece is the same as that of the piece card, for example, if a piece name of a first piece card is Character A, the first piece card is configured to summon a piece: Character A).

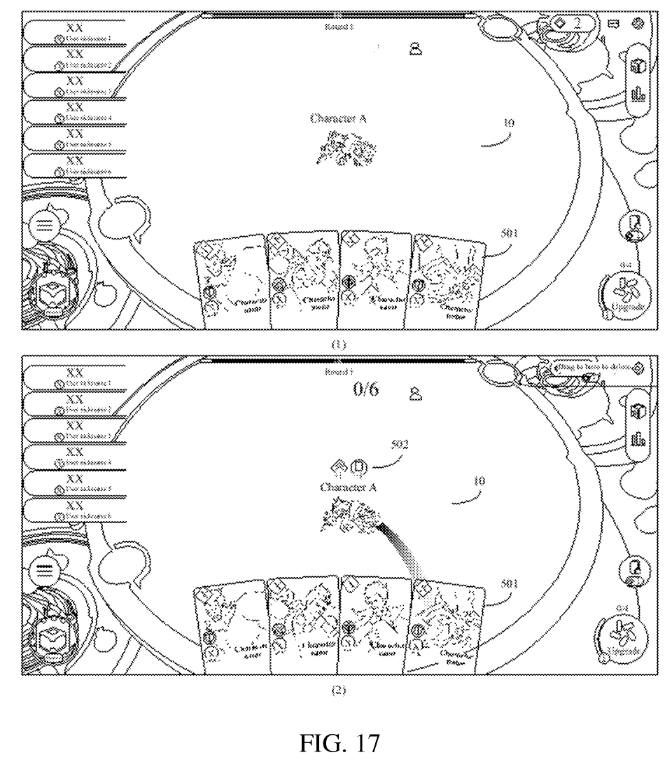

When a piece having a same name has already existed in the chessboard area (a piece name is the same as that of the piece card), a piece level of the piece is increased after the piece card is used. For example, as shown in (1) in FIG. 17, a first piece: Character A has already existed in a chessboard area 10, and a player uses a first piece card 501 (the first piece card 501 and the first piece have a same name, which is Character A). In this case, as shown in (2) in FIG. 17, after use of the first piece card 501, a level of the first piece in the chessboard area is increased from original level 1 to level 2.

For example, when the first piece card is selected, if the first piece having the same name as the first piece card has already existed in the card area before use of the first piece card, a use effect prompt of the first piece card is displayed. The use effect prompt is configured for prompting a piece level to which the first piece can be upgraded after use of the first piece card, and/or the use effect prompt is configured for prompting a quantity of pieces that can be obtained (or a quantity of effect cards) after use of the first piece card. For example, as shown in (2) in FIG. 17, a use effect prompt 502 is displayed above the head of Character A, +1 on the left side indicates that a level of Character A may be upgraded by 1 level after use of the first piece card 501, and +1 on the right side indicates that 1 effect card may be obtained after use of the first piece card 501.

When no piece having the same name exists in the chessboard area, the piece corresponding to the piece card is summoned in the chessboard area after use of the piece card, or the piece corresponding to the piece card is additionally displayed in the chessboard area after use of the piece card.

The effect card is configured to obtain a buff effect acting on the game match. An in-match effect of any game match may be achieved by using an effect card. In an example, except piece addition and equipment addition, all in-match effects may be achieved by using effect cards. For example, a buffer effect for this party in the battle, a debuff effect for the opposing party in the battle, a display effect in the game match, a change in match rules of the game match, a change in battle rules of each round of game battle, and the like may all be achieved by using effect cards. In an example, the effect card may alternatively be referred to as a strategy card, a skill card, a buff card, or a talent card.

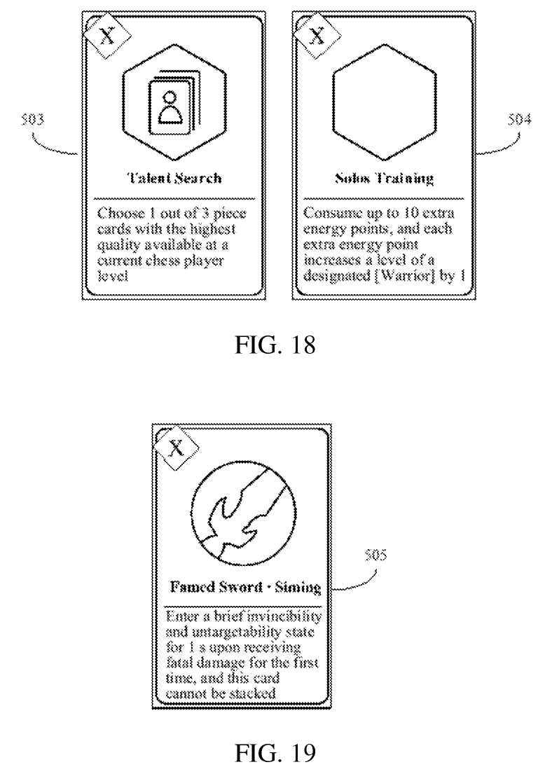

Examples of effects that may be obtained after use of several effect cards are described below. For example, as shown in FIG. 18, an effect card: Talent Search 503, achieves an effect of choosing 1 out of 3 piece cards with the highest quality available at a current chess player level. An effect card: Solo Training 504, achieves an effect of consuming up to 10 extra energy points, each extra energy point increasing a level of a designated [warrior] by 1.

For another example, an effect of an effect card after use may include at least one of the following: changing a virtual image of a chess player virtual character, or changing a chess player virtual character (that is, a chess player virtual character is changed in a match, to change a chess player skill of this party), or making the chess player of this party skip a next round (that is, the chess player of this party does not engage in a next round of game battle, and automatically win the next round of game battle), or changing an attribute (such as a piece type, a faction, an attack type, attack power, a piece level/star, a gender, an attack range, a health point, or defense power) of a piece of this party, or changing an attribute of a piece of the opponent, or changing a card held by this party (for example, changing a card price (an energy value required for using a card) of a held card, swapping a held card, changing a card type of a held card, increasing a card rank of a held card, drawing a card from the cards of the opponent and obtaining the card, or increasing an upper limit of the quantity of cards in the hand area of this party), or changing a card held by the opponent (for example, making the opponent discard a held card, or swapping a card held by the opponent with a card held by this party, or making the opponent unable to use a held card in a next round), or controlling the chess player virtual character to engage in a next round of game battle as a piece, or the like. These examples are merely for ease of understanding effects that may be obtained by using effect cards, and effects that can be obtained by using effect cards are not limited thereto.

For example, the effect card in the examples of this application is a card obtained by playing a piece card having a same name. In an example, the player obtains one effect card by playing a piece card having the same name as any piece of this party in the chessboard area.

Alternatively, the effect card may be obtained in another manner. For example, cards are dealt before each round starts, and the dealt cards may include an effect card. Alternatively, an effect card is obtained each time the pieces of this party defeat one piece of the opposing party. Alternatively, an effect card may be obtained by swapping a chess player card. For example, one effect card may be obtained by swapping three chess player cards.

In an example, the effect card includes at least one of an exclusive effect card and a universal effect card. The exclusive effect card is associated with a piece attribute, and the piece attribute includes at least one of a piece faction and a piece type. For example, the piece attribute is determined according to the piece faction and the piece type. Shu Kingdom Mage is one type of piece attribute, and this type of piece attribute corresponds to a first set of exclusive effect cards. Wu Kingdom Warrior is another type of piece attribute, and this type of piece attribute corresponds to a second set of exclusive effect cards. Wu Kingdom Assassin is still another type of piece attribute, and this type of piece attribute corresponds to a third set of exclusive effect cards. Each exclusive effect card uniquely corresponds to one piece attribute. However, the universal effect card is not associated with the piece attribute.

For example, effect cards may be classified into the exclusive effect card and the universal effect card according to effect card obtaining manners. The exclusive effect card is an effect card obtained by using a piece card having a reference piece attribute. The universal effect card is allowed to be obtained by using a piece card having any piece attribute. The reference piece attribute may include one or more piece attributes. The reference piece attribute may be set according to experience, or may be flexibly adjusted according to game rules of the round-based board game. This is not limited in the examples of this application.

For example, the exclusive effect card is an effect card obtained by using a piece card having the same name as the reference piece attribute. The piece card having the same name as the reference piece attribute refers to a piece card having the same name as a piece having the reference piece attribute. A piece name of the piece card having the same name as the reference piece attribute is the same as that of the piece having the reference piece attribute. In an example, the player plays a first piece card having the same name as a first piece having a first piece attribute in the chessboard area, to obtain one exclusive effect card corresponding to the first piece attribute. For example, if a Wei Kingdom Tank piece A exists in the chessboard area, when playing a piece card of the piece A, the player may obtain one exclusive effect card corresponding to Wei Kingdom Tank. For example, it is possible to obtain the exclusive effect card corresponding to the reference piece attribute by using the piece card having the same name as the reference piece attribute. The probability may be preset by a backend, for example, the probability is 50%.

However, the universal effect card does not limit a piece attribute of a piece card having a same name, and the player may obtain the universal effect card by playing a piece card having the same name as any piece in the chessboard area.

For example, effect cards may further be classified into the exclusive effect card and the universal effect card according to action objects of the effect cards. An action object of the exclusive effect card includes a piece corresponding to the piece attribute. An action object of the universal effect card does not limit a piece attribute.

For example, after use, the exclusive effect card can only produce an effect on a piece having the piece attribute that is associated with the exclusive effect card. For example, after use, one exclusive effect card corresponding to Wu Kingdom Assassin can only increase attack power of a Wu Kingdom Assassin piece of this party in the chessboard area, but cannot increase attack power of another piece of this party. However, after use, the universal effect card may act on a piece having any piece attribute. For example, if an effect of a universal effect card is also increasing attack power of a piece of this party, after use, the universal effect card increases attack power of all pieces of this party in the chessboard area.

In an example, the action object of the exclusive effect card may alternatively be not limited to the piece corresponding to the piece attribute. For example, action objects of some exclusive effect cards may be all pieces of this party, or action objects of some exclusive effect cards may be not pieces (for example, acting on other aspects such as a chess player, a card in hand, battle rules, and a round matching mechanism).

The equipment card is configured to add equipment to a piece. For example, one piece of equipment may be obtained after use of the equipment card, and the player may equip a piece in the chessboard area with the equipment. For example, only one piece of equipment can be obtained by using one equipment card, and one piece of equipment can be added to only one piece. Alternatively, one piece of equipment may be obtained by using one equipment card, and one piece of equipment may be added to at least two pieces (for example, equipping all pieces of this party with the equipment). The equipment may enhance an attribute (such as attack power, defense power, a health point, a critical rate, critical damage, skill cooldown time, penetration, an attack speed, cooldown reduction, a health regeneration speed, a movement speed, lifesteal, an attack range, or tenacity) of a piece of this party, or may provide a combat effect (for example, providing a shield, a resurrection opportunity, or invincibility time) for a piece.

For example, as shown in FIG. 19, an equipment card: Famous Sword · Siming 505 achieves an equipment effect of entering a brief invincible and untargetable state for 1 second upon receiving fatal damage for the first time, which cannot be stacked.

For example, the equipment card may be obtained by upgrading a level of a chess player. A specific quantity of equipment cards are dealt to the chess player each time the level of the chess player is upgraded. The equipment card may alternatively be obtained through purchase. Alternatively, the equipment card may be obtained in another manner. For example, cards are dealt when each round starts, and the dealt cards include at least one of a piece card, an equipment card, an effect card, and a chess player card.

The chess player card includes a card obtained through a chess player skill of a chess player virtual character. The chess player virtual character is a virtual character configured for controlling a piece, and the chess player virtual chess character is a virtual character played by a user account in a game match. For example, when the game match starts, each user account engaging in the game match needs to select a chess player virtual character to play in the current game match, and different chess player virtual characters have different chess player skills. A chess player card exclusive to the chess player virtual character may be obtained by using the chess player skill. In some examples, the chess player virtual character may be referred to as a chess player for short.

For example, a chess player skill of a first chess player is obtaining one chess player card after losing the round-based battle. In this case, one chess player card is automatically dealt to the first chess player each time the first chess player loses the round-based battle. The chess player skill may be a passive skill or an active skill. The chess player skill refers to a skill possessed by a chess player. The passive skill refers to a skill that continuously takes effect or automatically takes effect when a particular condition is satisfied. The active skill refers to a skill that requires a player to actively select the release timing.

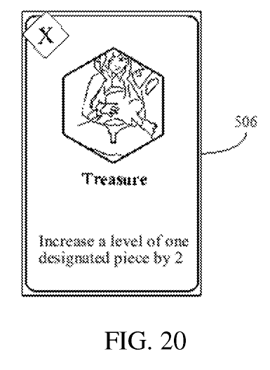

For example, as shown in FIG. 20, a chess player card: Treasure 506 achieves a card effect of increasing a level of one designated piece by 2.

For example, the cards are all drawn from a card pool, and the card pool is configured to store at least one card. For example, the card pool may alternatively be referred to as a card stack, and the player draws a card from the card stack.

Different types of cards may correspond to different card pools. The game match includes at least one of the following card pools: a piece card pool, an effect card pool, an equipment card pool, and a chess player card pool.

The piece card pool is configured to store piece cards, and the piece card pool is a common card pool shared by all chess player virtual characters in the game match. Only one piece card pool exists in one game match, and all chess player virtual characters draw piece cards from the same piece card pool.

For example, a quantity of piece cards in one game match is conserved. A total quantity of piece cards in one game match is conserved. The total quantity of piece cards includes: used piece cards (including used, discarded, and sold piece cards, and the like), piece cards held by a chess player virtual character, and piece cards in the piece card pool. Before the game match starts, all piece cards of the game match are stored in the piece card pool. In an example, the game match includes at least one game round, and before the game match starts means before the 1^{st} game round of the game match starts. In some examples, the 1^{st} game round of the game match may be referred to as a first game round of the game match. That is, before the first game round of the game match starts, all piece cards of the game match are stored in the piece card pool.

In an example, the used, discarded, and sold piece cards are not placed back into the piece card pool. Alternatively, the used piece cards are not placed back into the piece card pool, and the discarded piece card or sold piece cards are placed back into the piece card pool. In one game match, a value obtained by a quantity of remaining piece cards in the piece card pool + a quantity of piece cards taken out from the piece card pool - a quantity of piece cards placed back into the piece card pool is a constant value.

For example, it is assumed that the total quantity of piece cards in one game match is 1000, that the total quantity of piece cards in the game match is conserved means that in the game match, A, B, and C always satisfies A+B-C=1000, where A denotes the quantity of remaining piece cards in the piece card pool, B denotes the quantity of piece cards taken out from the piece card pool, and C denotes the quantity of piece cards placed back into the piece card pool.

The piece card pool includes at least two piece cards having a same name (piece cards having a same card name). A quantity of piece cards having a same name in the piece card pool has an upper limit. For example, the upper limit of the quantity of piece cards having the same name is 50. In an example, upper limits of quantities of piece cards having different card names may be the same or may be different. For example, an upper limit of a quantity of piece cards of Character A is 50, and an upper limit of a quantity of piece cards of Character B is 60.

For example, before the game match starts, a total of 1000 piece cards are stored in the piece card pool, including 20 types of piece cards having same names, and a quantity of each type of piece cards having a same name is 50.

The effect card pool is configured to store effect cards, and the effect card pool is a common card pool shared by all chess player virtual characters in the game match. A quantity of effect cards stored in the effect card pool has no upper limit. For example, only one effect card pool exists in one game match, and all chess player virtual characters draw effect cards from the same effect card pool. Alternatively, one exclusive effect card pool exists in one game match, and all chess player virtual characters draw exclusive effect cards from the same exclusive effect card pool; and one universal effect card pool exists in one game match, and all chess player virtual characters draw universal effect cards from the same universal effect card pool.

The effect card pool includes at least one of the following: the exclusive effect card pool configured to store exclusive effect cards and the universal effect card pool configured to store universal effect cards. In other words, the effect card pool includes at least one of the exclusive effect card pool and the universal effect card pool, the exclusive effect card pool is configured to store exclusive effect cards, and the universal effect card pool is configured to store universal effect cards.

In some examples, a quantity of exclusive effect cards in the exclusive effect card pool has no upper limit, and a quantity of universal effect cards in the universal effect card pool has no upper limit.

That a quantity of cards in a card pool has no upper limit may mean that the quantity of cards in the card pool is constant, and the quantity of cards in the card pool does not decrease after one card is drawn from the card pool. In this case, a probability of drawing each card from the card pool is fixed. The effect card pool is used as an example. For example, the effect card pool includes 100 effect cards, including 50 types of effect cards, and a quantity of each type of effect card is 2. After a first chess player virtual character draws one effect card from the effect card pool, there are still 100 effect cards in the effect card pool, and a drawing probability of each type of effect card is still 2%. The first chess player virtual character refers to any one of all chess player virtual character in the game match.

That the quantity of cards in the card pool has no upper limit may alternatively means that the quantity of cards in the card pool is not fixed, and a drawing probability of each type of card is constant. In this case, the drawing probability of each type of card in the card pool is fixed. For example, the effect card pool includes 50 types of cards, and a drawing probability of each type of card is 2%. After the first chess player virtual character draws one effect card from the effect card pool, the drawing probability of each type of effect card is still 2%.

That the quantity of cards in the card pool has no upper limit may alternatively means that an equal quantity of cards are replenished into the card pool from a candidate card pool each time the quantity of cards in the card pool decreases. The candidate card pool stores cards of same types as the cards in the card pool. In this case, the reduced cards and the added cards in the card pool may be different cards. Therefore, after the chess player virtual character draws a card from the card pool, drawing probabilities of various types of cards in the card pool may change. For example, after the first chess player virtual character draws a first effect card from the effect card pool, a second effect card is replenished into the effect card pool from the candidate card pool. Therefore, in the effect card pool, both a drawing probability of the first effect card and a drawing probability of the second effect card change.

The equipment card pool is configured to store equipment cards, and the equipment card pool is a common card pool shared by all chess player virtual characters in the game match. For example, only one equipment card pool exists in one game match, and all chess player virtual characters engaging in the game match draw equipment cards from the same equipment card pool.

A quantity of equipment cards stored in the equipment card pool has no upper limit. For example, the quantity of cards in the equipment card pool has no upper limit either. For a specific explanation, refer to the foregoing explanation of the effect card pool.

The chess player card pool is configured to store chess player cards, the chess player card pool corresponds to a chess player virtual character, and different chess player virtual characters correspond to different chess player card pools. For example, each chess player virtual character corresponds to a respective chess player card pool, and each chess player virtual character draws a chess player card from the respective chess player card pool.

In one game match, different user accounts use different chess player virtual characters (no two user accounts use a same chess player virtual character), which inevitably causes each user account to correspond to a respective chess player card pool.

In some examples, a plurality of user accounts may alternatively be allowed to use identical virtual characters in one game match. For example, both a first user account and a second user account select to use a first chess player virtual character. In this case, user accounts using a same chess player virtual character share a same chess player card pool, or user accounts using a same chess player virtual character each correspond to one chess player card pool.

A quantity of chess player cards stored in the chess player card pool has no upper limit. For example, the quantity of cards in the chess player card pool has no upper limit either. For a specific explanation, refer to the foregoing explanation of the effect card pool.

Operation 430: Display, in response to a use operation for the first card, that the first card acts on a game match of the round-based board game.

The use operation for the first card is an operation of playing the first card. For example, the use operation is an operation of dragging the first card toward the chessboard area of this party. Alternatively, the use operation includes a first click/tap operation and a second click/tap operation. The first click/tap operation is an operation of clicking/tapping to select the first card, and the second click/tap operation is an operation of clicking/tapping a square in the chessboard area of this party. Alternatively, the use operation includes a double-tap/double-tap operation for the first card. Alternatively, the use operation includes a slide operation generated on the first card. A specific form of the use operation is not limited in the examples of this application. In some examples, the use operation may alternatively be referred to as a card-playing operation.

For example, the player may use any card in the hand area.

For example, when the first card type is a piece card, the displaying, in response to a use operation for the first card, that the first card acts on a game match of the round-based board game includes: additionally displaying, in a case that no piece having a same name as the first card exists in deployed pieces of this party, a piece corresponding to the first card in response to the use operation for the first card; or displaying, in a case that a piece having a same name as the first card already exists in deployed pieces of this party and in response to the use operation for the first card, that a piece level of the piece having the same name as the first card is increased. The piece having the same name as the first card includes a piece whose piece name is the same as that of a piece corresponding to the first card.

In an example, the cards held by this party are displayed in the hand area of the match interface, the match interface further includes a chessboard area of this party, and the chessboard area of this party is configured to display deployed pieces of this party. In this case, that no piece having the same name as the first card exists in the chessboard area of this party means that no piece having the same name as the first card exists in the chessboard area of this party. Based on this, in a case that no piece having the same name as the first card exists in the chessboard area of this party, the piece corresponding to the first card is additionally displayed in the chessboard area of this party in response to the use operation for the first card; or in a case that the piece having the same name as the first card exists in the chessboard area of this party, in response to the use operation for the first card, it is displayed that the piece level of the piece having the same name as the first card is increased in the chessboard area of this party.

In an example, the additionally displaying the piece corresponding to the first card in response to the use operation for the first card includes: displaying at least two candidate squares and a first indication element in response to the use operation for the first card, the first indication element including at least one of a zoomed-out first card, the piece corresponding to the first card, and a first indication arrow; and additionally displaying, in response to a drag operation of dragging the first indication element to a first candidate square, the piece corresponding to the first card in the first candidate square, the first candidate square being any one of the at least two candidate squares.

In an example, in a case that the deployed pieces of this party are displayed in the chessboard area of this party, the at least two candidate squares and the first indication element are displayed in the chessboard area of this party in response to the use operation for the first card.

In a case that the first indication element includes the first indication arrow, a starting point of the first indication arrow is a position of the first card before use, and an end point of the first indication arrow is a real-time position of the drag operation. The at least two candidate squares may be all candidate squares or candidate squares only belonging to this party. The at least two candidate squares may be always displayed, or may be displayed only when a use operation for a card is recognized.

For example, when the first card type is an effect card, the displaying, in response to a use operation for the first card, that the first card acts on a game match of the round-based board game includes: displaying an effect of the first card after use in response to the use operation for the first card.

In an example, when the first card type is an effect card, the effect of the first card after use may include at least one of adding an effect to at least one piece of this party and adding an effect to a card obtaining process.

For example, adding an effect to at least one piece of this party may include: adding a buff exclusive to a piece type, adding a combined buff when at least two pieces of a same faction are deployed at the same time, and the like. Adding an effect to the card obtaining process may include: drawing two identical piece cards consecutively.

For example, when the first card type is an equipment card, the displaying, in response to a use operation for the first card, that the first card acts on a game match of the round-based board game includes: displaying, in response to the use operation for the first card, that virtual equipment corresponding to the first card is obtained.

In an example, the displaying, in response to the use operation for the first card, that virtual equipment corresponding to the first card is obtained includes: displaying a second indication element in response to the use operation for the first card, the second indication element including at least one of the zoomed-out first card, the virtual equipment corresponding to the first card, and a second indication arrow; and displaying, in response to a drag operation of dragging the second indication element to a piece of this party among the deployed pieces of this party, that the piece of this party is equipped with the virtual equipment corresponding to the first card. The piece of this party refers to any one of the deployed pieces of this party.

In an example, in a case that the deployed pieces of this party are displayed in the chessboard area of this party, the drag operation of dragging the second indication element to the piece of this party among the deployed pieces of this party refers to a drag operation of dragging the second indication element to the piece of this party in the chessboard area of this party.

In a case that the second indication element includes the second indication arrow, a starting point of the second indication arrow is a position of the first card before use, and an end point of the second indication arrow is a real-time position of the drag operation.

For example, when the first card type is a chess player card, the displaying, in response to a use operation for the first card, that the first card acts on a game match of the round-based board game includes: displaying an effect of the first card after use in response to the use operation for the first card.

In an example, when the first card type is a chess player card, the effect of the first card after use may include at least one of the following: adding a piece of this party, reducing a piece of this party, upgrading a pieces of this party, adding an effect to a piece of this party, equipping a piece of this party with equipment, obtaining a new card, selling a card, exchanging for a card, or increasing a health point of a player object of this party.

In conclusion, in the method according to this example, the strategic mechanisms in the round-based board game are presented in the form of cards, to provide a plurality of different types of cards. Cards obtained by a player are uniformly displayed, for example, are uniformly displayed in the hand area of the match interface, and a match decision-making operation in any dimension is performed by playing a corresponding card. This simplifies a manner of making a match decision. Different strategic mechanisms are implemented by using different card types, and different obtaining conditions are set for different card types, to correspondingly satisfy different obtaining manners for battle elements, such as a piece, equipment, an effect, and a skill, in different strategic mechanisms. In the game match, the player can quickly and conveniently perform decision-making operations of different strategic mechanisms only by observing held cards in the hand area and performing use operations for the cards without paying attention to other information, such as another area of the match interface. This helps the player quickly make a match decision in the fast-paced round-based board game, to improve human-computer interaction efficiency. In this way, match duration of the game match is shortened, service duration of a server for the game match is shortened, and resources of the server are saved.

In addition, in a round-based board game in the related art, the player needs to actively obtain battle elements (a piece, equipment, a skill, and the like) of the strategic mechanisms in the game. For example, a piece obtaining process in conventional auto chess is "massively filtering in a shop + purchase a desired piece with gold", and the player needs to purchase the desired piece from dozens of available pieces in the shop. Because each piece typically has only one three-dimensional model and a name, the player needs to understand and filter dozens pieces of information. It can be seen that the player needs to select a battle element that the player may need from a large quantity of available battle elements, actively plans an obtaining strategy to obtain these battle elements, uses these battle elements for strategic deployment, and applies the battle elements to a game battle. It can be seen that the player needs to consider too much content, and performs excessively complicated and overloaded operations. In the method provided in this application, battle elements in various strategic mechanisms are implemented as different types of cards, the different types of cards are automatically obtained based on corresponding obtaining conditions, and a process of obtaining the battle elements is changed to be implemented by the cards automatically dealt by the system. The player typically only has 2 to 8 cards in hand, and only needs to understand and filter 2 to 8 pieces of information. In addition, the card is naturally suitable for carrying text information, which is convenient for the player to understand and read. Therefore, "randomly and automatically drawing cards first + manually swapping a disliked card by the player" in this application can improve human-computer interaction efficiency, and reduce an amount of information and a quantity of operations that need to be processed by a user, and is suitable for a novice player.

For example, different types of cards may be obtained in different obtaining manners.

### Piece card

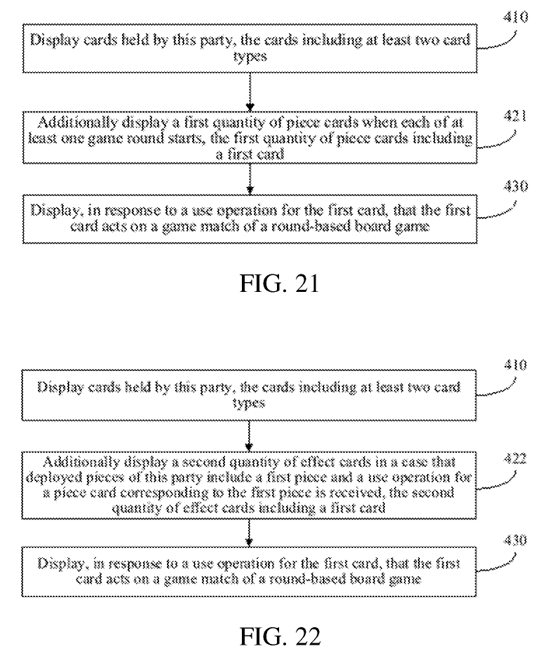

FIG. 21 is a flowchart of a match playing method for a round-based board game according to an example of this application. The method may be performed by a computer device, and the computer device may include a terminal or a server. The method may be performed by any terminal in FIG. 1 or a client running on any terminal. The client is a client of a round-based board game. Based on the example shown in FIG. 16, operation 420 includes operation 421.

Operation 421: Additionally display a first quantity of piece cards when each of at least one game round starts, the first quantity of piece cards including the first card.

For example, in a case that operation 420 includes operation 421, the first card type includes a piece card, and the first obtaining condition corresponding to the first card type includes that each of the at least one game round starts.

In an example, in a case that the cards held by this party are displayed in the hand area of the match interface, the additionally displaying a first quantity of piece cards refers to additionally displaying the first quantity of piece cards in the hand area.

For example, the first card type includes a piece card; and the game match includes at least one game round. Before each game round starts, the first quantity of piece cards are dealt to each chess player surviving in a current game match. The quantities of piece cards obtained by the chess players may be the same or different. For example, initial quantities of piece cards that can be obtained by the chess players in each game round are the same, but some chess players may increase the card quantities of piece cards that can be obtained in each game round by using effect cards or chess player cards.

For example, the first quantity of piece cards are drawn from a piece card pool. A terminal receives a first card dealing result. The first card dealing result carries indication information of the first quantity of piece cards, and the first quantity of piece cards are randomly determined from the piece card pool. The terminal additionally displays the first quantity of piece cards in the hand area. For example, the terminal randomly draws the first quantity of piece cards from the piece card pool, or a server randomly draws the first quantity of piece cards from the piece card pool. The first quantity is greater than or equal to 1, and the first quantity may be set according to experience, or may be flexibly adjusted according to game rules of the round-based board game. This is not limited in the examples of this application.

For example, the piece card may alternatively be obtained by using an effect card or a chess player card. For example, if a use effect of an effect card/chess player card is obtaining a piece card after use, when using the effect card/chess player card, the player may obtain the piece card.

### Effect card

FIG. 22 is a flowchart of a match playing method for a round-based board game according to an example of this application. The method may be performed by a computer device, and the computer device may include a terminal or a server. The method may be performed by any terminal in FIG. 1 or a client running on any terminal. The client is a client of a round-based board game. Based on the example shown in FIG. 16, operation 420 includes operation 422.

Operation 422: Additionally display a second quantity of effect cards in a case that deployed pieces of this party include a first piece and a use operation for a piece card corresponding to the first piece is received, the second quantity of effect cards including the first card.

For example, in a case that operation 420 includes operation 422, the first card type includes an effect card, and the first obtaining condition corresponding to the first card type includes that: the deployed pieces of this party include the first piece, and the use operation for the piece card corresponding to the first piece is received. The first piece may be any one of the deployed pieces of this party.

In an example, in a case that the cards held by this party are displayed in the hand area of the match interface, and the deployed pieces of this party are displayed in the chessboard area of this party of the match interface, the additionally displaying a second quantity of effect cards in a case that deployed pieces of this party include the first piece and a use operation for a piece card corresponding to the first piece is received includes: additionally displaying the second quantity of effect cards in the hand area in a case that the first piece is displayed in the chessboard area of this party and the use operation for the piece card corresponding to the first piece is received.

The first card type includes an effect card; and the match interface further includes the chessboard area of this party. The chessboard area of this party is configured to display the deployed pieces of this party. The first piece may be any piece in the chessboard area of this party. The piece card corresponding to the first piece may be a piece card having the same name as the first piece, that is, a piece name of the piece card corresponding to the first piece is the same as that of the first piece.

The examples of this application provide a manner of obtaining an effect card, that is, the second quantity of effect cards may be obtained by using one piece card having the same name as a piece of this party in the chessboard area. The second quantity is greater than or equal to 1, and the second quantity may be set according to experience, or may be flexibly adjusted according to game rules of the round-based board game. This is not limited in the examples of this application.

For example, the second quantity is 1, and pieces of this party in the chessboard area include: a piece 1, a piece 2, piece 3, and piece 4. In this case, the player object may obtain one effect card by using a piece card 1 corresponding to the piece 1, or may obtain one effect card by using a piece card 4 corresponding to the piece 4, but may not obtain an effect card by using a piece card 5 corresponding to a piece 5. The piece card 1 is a piece card having the same name as the piece 1, the piece card 4 is a piece card having the same name as the piece 4, and the piece card 5 is a piece card having the same name as the piece 5.

The effect card is obtained by playing a piece card. When an effect of the piece card is adding one piece to the chessboard, the effect card is not obtained; or when an effect of the piece card is increasing a chess level of an existing piece on the chessboard, an effect card is additionally given to the player. For example, no pieces having a same name exist in the pieces of this party in the chessboard area, that is, only one piece of each piece name exists. When one type of piece has already existed, only a piece level of the piece that has already existed on the chessboard is increased when a piece card corresponding to the piece is played, and no piece having a same name is added to the chessboard.

For example, a card type of the additional effect card is related to a piece attribute of the played piece card. The effect card includes at least one of an exclusive effect card and a universal effect card. In an example, in a case that the effect card includes only an exclusive effect card, the terminal additionally displays a second quantity of exclusive effect cards of a first type. The exclusive effect cards of the first type correspond to a piece attribute of the first piece. In a case that the effect card includes only a universal effect card, the terminal additionally displays a second quantity of universal effect cards. In a case that the effect card includes an exclusive effect card and a universal effect card, the terminal randomly performs (for example, randomly selects one operation from the following two operations according to a probability of 50% to perform) one of the following operations: additionally displaying a second quantity of universal effect cards; and additionally displaying a second quantity of exclusive effect cards of a first type, the exclusive effect cards of the first type corresponding to a piece attribute of the first piece.

In an example, the additionally displaying a second quantity of universal effect cards includes: additionally displaying the second quantity of universal effect cards in the hand area; and the additionally displaying a second quantity of exclusive effect cards of a first type includes: additionally displaying the second quantity of exclusive effect cards of the first type in the hand area.

After the piece card having the same name is played, a probability of obtaining the second quantity of universal effect cards is 50%, and a probability of obtaining the second quantity of exclusive effect cards corresponding to the piece attribute of the piece card having the same name is 50%.

For example, the terminal receives a second card dealing result. The second card dealing result carries indication information of the second quantity of universal effect cards, and the second quantity of universal effect cards are randomly determined from a universal effect card pool according to a chess player level of the chess player virtual character of this party. In an example, the terminal may draw the universal effect cards from the universal effect card pool, or the server may draw the universal effect cards from the universal effect card pool.

In an example, a universal effect card in the universal effect card pool corresponds to a lowest chess player level, and the lowest chess player level corresponding to the universal effect card indicates a lowest chess player level required for the chess player virtual character to be eligible to obtain the universal effect card. The randomly determining the second quantity of universal effect cards from the universal effect card pool according to the chess player level of the chess player virtual character of this party includes: randomly determining the second quantity of universal effect cards from candidate universal effect cards in the universal effect card pool, the candidate universal effect card being a universal effect card corresponding a lowest chess player level that is lower than or equal to the chess player level of the chess player virtual character of this party in the universal effect card pool. That is, the lowest chess player level corresponding to the second quantity of universal effect cards is lower than or equal to the chess player level of the chess player virtual character of this party.

For example, the terminal receives a third card dealing result. The third card dealing result carries indication information of the second quantity of exclusive effect cards of the first type, and the second quantity of exclusive effect cards of the first type are randomly determined from an exclusive effect card pool according to the piece attribute of the first piece. In an example, the terminal may draw the exclusive effect cards from the exclusive effect card pool, or the server may draw the exclusive effect cards from the exclusive effect card pool.

In an example, an exclusive effect card in the exclusive effect card pool corresponds to a reference piece attribute, and the exclusive effect card is obtained by using a piece card having the reference piece attribute. The randomly determining the second quantity of exclusive effect cards of the first type from the exclusive effect card pool according to the piece attribute of the first piece includes: randomly determining the second quantity of exclusive effect cards of the first type from candidate exclusive effect cards in the exclusive effect card pool, the candidate exclusive effect card being an exclusive effect card corresponding to a reference piece attribute that includes the piece attribute of the first piece in the exclusive effect card pool. That is, the reference piece attribute corresponding to the second quantity of exclusive effect cards of the first type includes the piece attribute of the first piece.

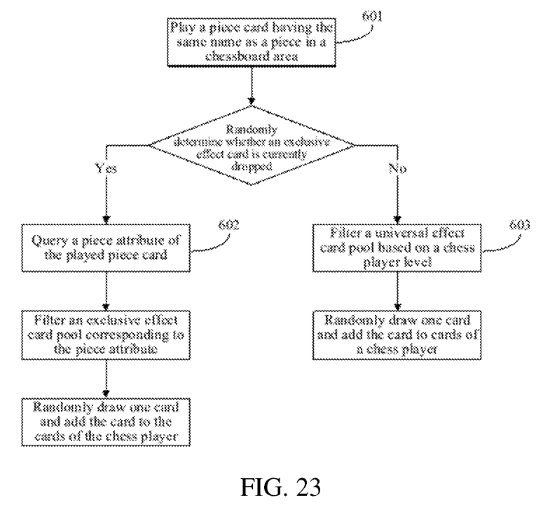

For example, as shown in FIG. 23, operation 601: Perform random determination after a player plays a piece card having a same name as a piece in a chessboard area, to determine whether an exclusive effect card is currently dropped, and perform operation 602 if the exclusive effect card is currently dropped, or perform operation 603 is no exclusive effect card is currently dropped. Operation 602: Query a piece attribute of a played piece card (such as a corresponding faction of a played piece card having a same name), filter an exclusive effect card pool corresponding to the piece attribute, and randomly draw one exclusive effect card from the exclusive effect card pool corresponding to the piece attribute and add the exclusive effect card to cards of a chess player selected by the player. Operation 603: Filter a universal effect card pool based on a current chess player level of the player, and randomly draw one universal effect card and add the universal effect card to the cards of the chess player selected by the player.

For example, when the universal effect card is drawn from the universal effect card pool, some universal effect cards may further be filtered out from the universal effect card pool in advance according to the chess player level. For example, if some universal effect cards are unavailable for some chess player levels, the universal effect cards may be first filtered out from the universal effect card pool, and then a universal effect card is drawn from the universal effect card pool, to improve efficiency of drawing a universal effect card from the universal effect card pool and improve reliability of the drawn universal effect card.

For example, for manners of obtaining the equipment card and the chess player card, refer to the description in the example shown in FIG. 16.

In conclusion, in the method according to this example, the strategic mechanisms in the round-based board game are presented in the form of cards, to provide a plurality of types of cards such as a chess player card, a piece card, an effect card, and an equipment card. Cards obtained by a player are uniformly displayed, for example, are uniformly displayed in the hand area of the match interface, and a match decision-making operation in any dimension is performed by playing a corresponding card. This simplifies a manner of making a match decision. Different strategic mechanisms are implemented by using different card types, and different obtaining conditions are set for different card types, to correspondingly satisfy different obtaining manners for battle elements, such as a piece, equipment, an effect, and a skill, in different strategic mechanisms. For example, a piece card is automatically dealt when a round starts, an effect card is obtained by playing the piece card, an equipment card is obtained when a chess player is upgraded, and a chess player card is obtained when a chess player skill is triggered. This satisfies different obtaining manners for different strategic mechanisms. In addition, match decisions that can be implemented by different strategic mechanisms are all uniformly displayed, for example, are uniformly displayed in the hand area. In the game match, the player can quickly and conveniently perform decision-making operations of different strategic mechanisms only by observing held cards in the hand area and performing use operations for the cards without paying attention to another area of the match interface. This helps the player quickly make a match decision in the fast-paced round-based board game, to improve human-computer interaction efficiency. In this way, match duration of the game match is shortened, service duration of a server for the game match is shortened, and resources of the server are saved.

For example, when a card-swapping operation is performed, different types of cards may be swapped with new cards by using different card swapping methods.

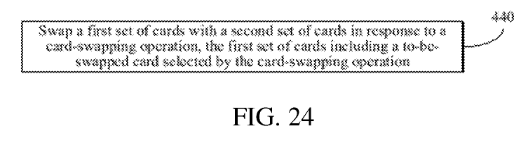

FIG. 24 is a flowchart of a match playing method for a round-based board game according to an example of this application. The method may be performed by a computer device, and the computer device may include a terminal or a server. The method may be performed by any terminal in FIG. 1 or a client running on any terminal. The client is a client of a round-based board game. Based on the example shown in FIG. 16, the method further includes operation 440. Operation 440 may be performed after operation 410.

Operation 440: Swap a first set of cards with a second set of cards in response to a card-swapping operation, the first set of cards including a to-be-swapped card selected by the card-swapping operation.

The second set of cards are determined according to card types included in the first set of cards and a quantity of cards of each card type, and the second set of cards have no overlap with the first set of cards. The first set of cards may include one card or a plurality of cards. A quantity of cards included in the second set of cards is the same as a quantity of cards included in the first set of cards.

In an example, the cards held by this party are displayed in the hand area of the match interface. In this case, the swapping a first set of cards with a second set of cards refers to swapping the first set of cards with the second set of cards in the hand area.

For example, the player may further perform a card-swapping operation. In the preparation phase of each round, the player may obtain a card-swapping opportunity. In an example, if the player loses the battle in a previous round, the player may obtain an additional card-swapping opportunity, that is, a losing player may obtain two card-swapping opportunities in a next round. The player may use the card-swapping opportunity to swap a card in hand. For example, a quantity of cards that can be swapped through one card-swapping operation may be not limited, or the quantity of cards that can be swapped through one card-swapping operation may have an upper limit.

In some examples, a card swap control is displayed on the match interface. A card swap interface is displayed in response to a trigger operation for the card swap control, and the card swap interface displays the hand area and a card swap area. A card-swapping operation is obtained in response to a confirmation operation of moving the first set of cards in the hand area from the hand area to the card swap area. The card swap control may be a button or a triggerable icon. The trigger operation for the card swap control may include a click/tap operation or another operation.

In an example, a confirm control is further displayed on the card swap interface. After the first set of cards in the hand area are moved from the hand area to the card swap area, the confirmation operation of moving the first set of cards in the hand area from the hand area to the card swap area is obtained in response to a trigger operation for the confirm control.

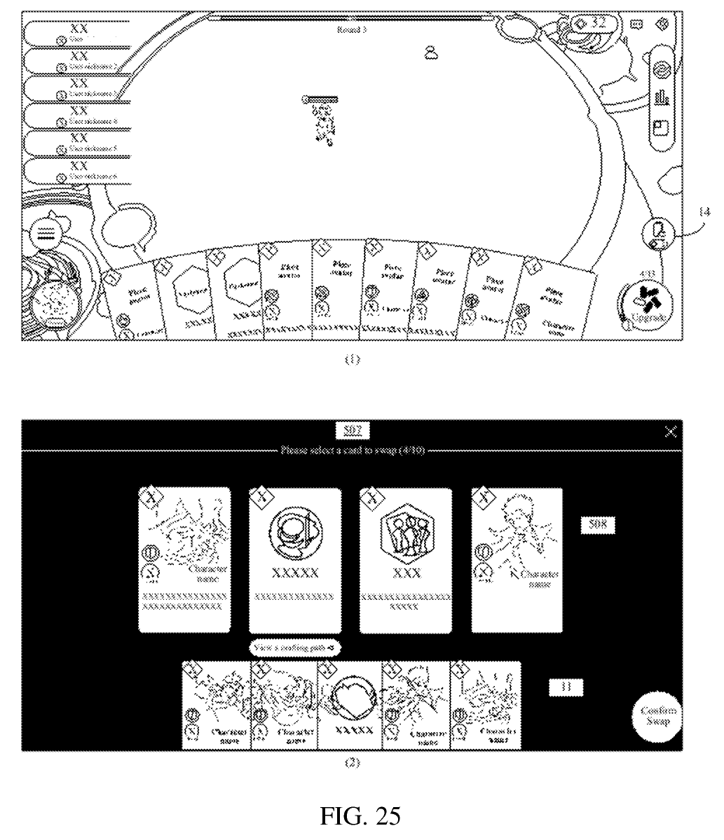

For example, as shown in (1) in FIG. 25, the hand area and a card swap button 14 are displayed on the match interface, and 9 hands exist in the hand area. After the player triggers the card swap button 14, a card swap interface 507 as shown in (2) in FIG. 25 is displayed. A hand area 11 and a card swap area 508 are displayed on the card swap interface 507. The player may select a card that the player wants to swap (the first set of cards) in the hand area 11 and move the card to the card swap area 508, for example, selects four cards that the player wants to swap and moves the four cards to the card swap area 508. Then, the player triggers a control (the confirm control) marked with "Confirm Swap" to swap the four selected cards with new cards.

For example, the first set of cards are cards that need to be swapped, and the second set of cards are newly obtained cards. The card in the first set of cards does not exist in the second set of cards, that is, a card discarded during current swapping is not obtained again through current swapping. In an example, in a subsequent card drawing process, a drawing probability of these discarded cards may alternatively be reduced. For example, a quantity of discarded cards is the same as a quantity of newly obtained cards, that is, a quantity of cards are discarded, and an equal quantity of cards are newly obtained.

For example, a type of the newly obtained card is determined according to a card type of the discarded card. The cards are swapped by using at least one of the following methods:

Method 1: In a case that the first set of cards includes a third quantity of piece cards, the second set of cards includes the third quantity of piece cards.

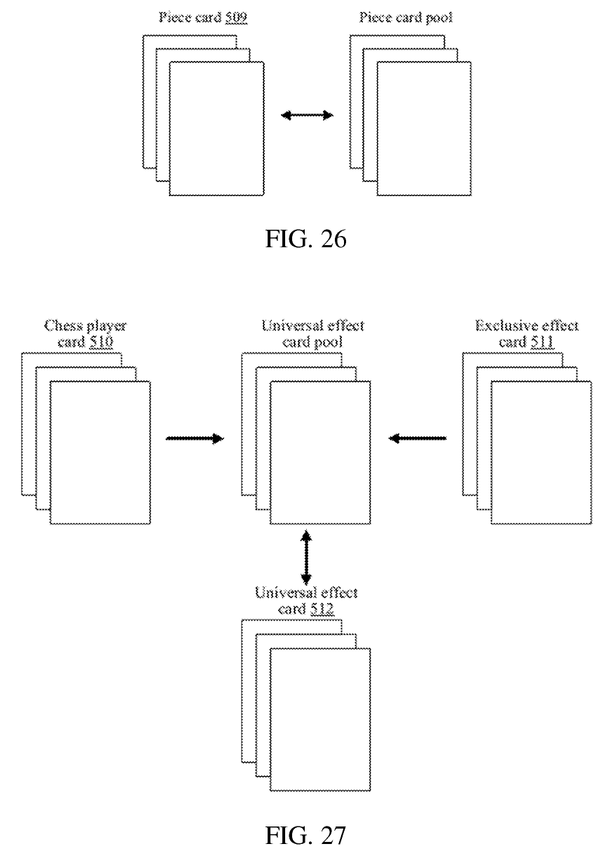

That is, a quantity of piece cards are discarded, and an equal quantity of piece cards are newly obtained. As shown in FIG. 26, a piece card 509 is swapped through a piece card pool. When the player requests to swap the piece card 509, an equal quantity of piece cards are drawn from the piece card pool and given to the player.

In an example, the discarded piece card needs to be placed back into the piece card pool. The first set of cards includes the third quantity of piece cards. In this case, the terminal/server places the first set of cards back into the piece card pool; and randomly determines the third quantity of piece cards from a candidate piece card pool to obtain the second set of cards. The candidate piece card pool includes a card pool obtained after a first card having a same name is removed from the piece card pool, and the first card having the same name includes a card whose card name is the same as that of a piece card in the first set of cards.

For example, the piece card pool may be filtered based on a piece card discarded during current swapping, and a card having a same name is filtered out from the piece card pool, to obtain the candidate piece card pool. Then, a piece card newly obtained during current swapping is filtered from the candidate piece card pool. This ensures that the piece card discarded during current swapping is not drawn, and improves reliability of card swapping.

Method 2. In a case that a total quantity of universal effect cards, exclusive effect cards, and chess player cards in the first set of cards is a fourth quantity, the second set of cards includes the fourth quantity of universal effect cards.

That is, the discarded universal effect cards, exclusive effect cards, and chess player cards are swapped with an equal quantity of universal effect cards. As shown in FIG. 27, a chess player card 510, an exclusive effect card 511, and a universal effect card 512 are swapped through a universal effect card pool. When the player requests to swap the chess player card 510, the exclusive effect card 511, or the universal effect card 512, an equal quantity of universal effect cards are drawn from the universal effect card pool and given to the player.

For example, because a quantity of cards in the universal effect card pool has no upper limit, the discarded universal effect cards, exclusive effect cards, or chess player cards may not need to be placed back into a corresponding card pool. The total quantity of universal effect cards, exclusive effect cards, and chess player cards in the first set of cards is the fourth quantity. In this case, the second set of cards includes the fourth quantity of universal effect cards randomly determined from a candidate universal effect card pool. The candidate universal effect card pool includes a card pool obtained after a second card having a same name is removed from the universal effect card pool, and the second card having the same name includes a card whose card name is the same as that of a universal effect card in the first set of cards.

For example, the universal effect card pool may be filtered based on a universal effect card discarded during current swapping, and a card having a same name is filtered out from the universal effect card pool, to obtain the candidate universal effect card pool. Then, a universal effect card newly obtained during current swapping is filtered from the candidate universal effect card pool. This ensures that the universal effect card discarded during current swapping is not drawn, and improves reliability of card swapping.

Method 3. In a case that the first set of cards includes a fifth quantity of equipment cards, the second set of cards includes the fifth quantity of equipment cards.

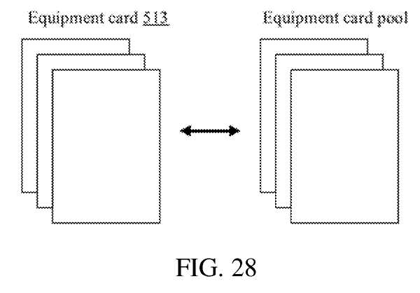

That is, a quantity of equipment cards are discarded, and an equal quantity of equipment cards are newly obtained. As shown in FIG. 28, an equipment card 513 is swapped through an equipment card pool. When the player requests to swap the equipment card 513, an equal quantity of equipment cards are drawn from the equipment card pool and given to the player.

For example, the first set of cards includes the fifth quantity of equipment cards. In this case, the second set of cards includes the fifth quantity of equipment cards randomly determined from a candidate equipment card pool. The candidate equipment card pool includes a card pool obtained after a third card having a same name is removed from the equipment card pool, and the third card having the same name includes a card whose card name is the same as that of an equipment card in the first set of cards.

For example, the equipment card pool may be filtered based on an equipment card discarded during current swapping, and a card having a same name is filtered out from the equipment card pool, to obtain the candidate equipment card pool. Then, an equipment card newly obtained during current swapping is filtered from the candidate equipment card pool. This ensures that the equipment card discarded during current swapping is not drawn, and improves reliability of card swapping.

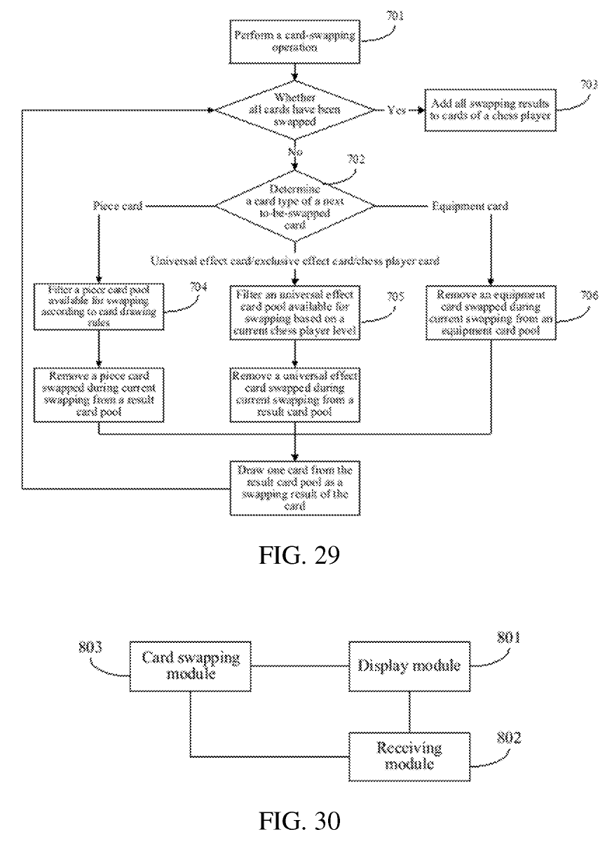

For example, as shown in FIG. 29, operation 701: Determine whether all cards have been swapped when a player performs a card-swapping operation, and perform operation 703 if all cards have been swapped, or perform operation 702 if not all cards have been swapped. Operation 702: Determine a card type of a next to-be-swapped card, and perform operation 704 if the card type is a "piece card"; or perform operation 705 if the card type is an "exclusive effect card" or a "chess player card" or a "universal effect card"; or perform operation 706 if the card type is an "equipment card". Operation 704: Filter a piece card pool available for swapping according to card drawing rules, remove all piece cards swapped during current swapping, randomly draw one card from a result card pool as a swapping result of the to-be-swapped card, and perform operation 701 after the foregoing process is completed. Operation 705: Filter a universal effect card pool available for swapping based on a chess player level, remove all universal effect cards swapped during current swapping, randomly draw one card from a result card pool as a swapping result of the to-be-swapped card, and perform operation 701 after the foregoing process is completed. Operation 706: Remove all equipment cards swapped during current swapping from an equipment card pool, randomly draw one card from a result card pool as a swapping result of the to-be-swapped card, and perform operation 701 after the foregoing process is completed. Operation 703: Add cards corresponding to all swapping results to cards of a chess player, to complete current card swapping.

In an example, a third set of cards are discarded in response to a card-discarding operation. For example, in a case that the cards held by this party are displayed in the hand area of the match interface, the discarding a third set of cards refers to discarding the third set of cards in the hand area. In an example, the third set of cards may be converted into a corresponding energy value, and the player may purchase a new card by using the energy value. The third set of cards includes a to-be-discarded card selected by the card-discarding operation. The third set of cards may include one card or a plurality of cards.

In conclusion, in the method according to this example, after pieces are transformed into cards, the round-based board game automatically randomly deals a card to a player, and the randomly dealt card may be not a card required by the player. Based on this, the examples of this application further provide the card swapping method. The player may swap a held card through a card-swapping operation, discard an undesired card, and obtain a new card. This improves a probability that the player obtains a desired card, helps the player execute a desired battle strategy, enhances interaction experience of the player, and improves human-computer interaction efficiency.

In the auto chess game in the related art, equipment, spells, and heroes are all included in a same common card pool. Equipment cards and effect cards are primarily purchased from the shop as commodities that are randomly drawn from the common card pool, and are considered to be of a same tier as hero cards.

Because no tier distinctions exist and existence of effect cards and equipment cards is determined according to a random probability, the player cannot control obtaining of cards. If a result is undesired, the player can draw cards once again only through a refresh operation, and cannot effectively control a variance in results.

Therefore, for the foregoing problem, the examples of this application provide a mechanism for classifying cards into a plurality of card pool types in auto chess, which are a hero card pool/a universal effect card pool/an exclusive effect card pool/an equipment card pool, respectively. Card drawing methods includes: obtaining a card from the hero card pool, playing a card having a same name to randomly obtain a card from the universal effect card pool and the exclusive effect card pool, and obtaining, when a card-swapping operation is performed, a new card from a designated card pool according to a card pool type to which a swapped card belongs.

Moreover, when the new is obtained through the card-swapping operation, an obtaining probability of the swapped card is significantly reduced. This eliminates a drawing probability of the swapped card.

In the examples of this application, an obtaining expectation of the effect card is converged. The player primarily obtains the effect card by playing a card having the same name as a deployed character, and the obtained effect card and the played card belong to a same faction. This ensures that the obtained effect card definitely synergizes with a current faction composition, and provides learning guidance to some extent. In addition, only the hero card pool is used as the common card pool, and a quantity of cards having a same name is limited, but a quantity of cards in the effect card pool is unlimited. This effectively controls a ratio of various types of cards obtained by the player in a match, and ensures that the game flow of the player is less frustrating and a ratio of obtained resources is proper.

### Classification of card types

According to card types, card pools in a game may be classified into:

### Hero card pool (piece card pool)

The card pool includes only hero cards (piece cards) of all factions, and a quantity of cards having a same name is set with an upper limit. The card pool is a common card pool. In a match, if a player retains a card from the card pool, other players engaging in the match may be affected.

### Effect card pool

The effect card pool is classified into: a piece type/faction effect card pool, including faction effect cards (exclusive effect cards) highly adapted to factions; and

a universal effect card pool, including versatile universal effect cards (universal effect cards) without faction restrictions.

A quantity of cards in the card pool has no upper limit.

### Equipment card pool

The card pool includes only equipment cards (equipment cards), and a quantity of cards in the card pool has no upper limit.

### Chess player card

The card pool is determined based on a chess player selected by a player when a match starts, and a quantity of cards in the card pool has no upper limit.

### Classification of card obtaining methods

### Replenish cards when a round starts

2 cards are replenished by default when the round starts, and the cards always come from the hero card pool.

### Play a card having the same name as a deployed character

A card having the same name as a deployed hero is displayed in a highlighted manner.

A faction effect card of a faction corresponding to the character or a universal effect card may be obtained by playing the card having the same name.

### Perform card swapping

In a card-playing phase, a card swap button is clicked/tapped to perform card swapping.

Any quantity of cards is selected for card swapping, an upper limit of the quantity is 10, and card swapping is completed by clicking/tapping a "Confirm Swap".

### Card pool rules corresponding to card swapping results

### Hero card swapping

Cards in the hero card pool can only be swapped with each other. Performing swapping is considered as executing a hero card drawing logic again, and a card swapped during current swapping is not drawn during current swapping.

### Effect card swapping

Swapping results of a chess player effect card, a faction effect card, and a universal effect card are all universal effect cards, and an effect card swapped during current swapping is not drawn during current swapping.

### Equipment card swapping

Cards in the equipment card pool can only be swapped with each other, and a card swapped during current swapping is not drawn during current swapping.

In conclusion, in the method according to the examples of this application, effect cards are obtained by repeatedly playing hero cards having the same name, and possible results of different types of cards during swapping are constrained, to achieve the following effects:
(1) it is ensured that all cards drawn by a player in a basic round are hero cards, to meet a requirement of the player for a basic faction composition;
(2) a drawing probability of a card in a card pool is converged, to help the player conveniently control a drawing strategy for the card pool;
(3) it is convenient for the player to understand different card pool types, distinguish effects of cards in different card pools, and learn and understand the game; and
(4) a ratio of various cards obtained by the player in a match is controlled, to ensure a proper game flow of the player and a proper ratio of obtained resources.

Apparatus examples of this application are described below. For details not described in detail in the apparatus examples, refer to the foregoing method examples.

FIG. 30 is a block diagram of a match playing apparatus for a round-based board game according to an example of this application. The apparatus includes: a display module 801, configured to display cards held by this party, the cards including at least two card types, the display module 801 being configured to display a first card in a case that a first obtaining condition corresponding to a first card type is satisfied, the first card being a card of the first card type, the first card type being any one of the at least two card types, and different card types corresponding to different obtaining conditions; and the display module 801 being configured to display, in response to a use operation for the first card, that the first card acts on a game match of the round-based board game.

In an example, the at least two card types include at least two of the following card types: a piece card, an effect card, an equipment card, and a chess player card.

The piece card is configured to summon a piece or upgrade a piece. The effect card is configured to obtain a buff effect acting on the game match. The equipment card is configured to equip a piece with equipment. The chess player card includes a card obtained through a chess player skill of a chess player virtual character, and the chess player virtual character is a virtual character configured for controlling a piece.

In an example, the game match includes at least one of the following card pools: a piece card pool, an effect card pool, an equipment card pool, and a chess player card pool.

The piece card pool is configured to store piece cards, and the piece card pool is a common card pool shared by all chess player virtual characters in the game match.

The effect card pool is configured to store effect cards, and the effect card pool is a common card pool shared by all chess player virtual characters in the game match.

The equipment card pool is configured to store equipment cards, and the equipment card pool is a common card pool shared by all chess player virtual characters in the game match.

The chess player card pool is configured to store chess player cards, the chess player card pool corresponds to a chess player virtual character, and different chess player virtual characters correspond to different chess player card pools.

In an example, before the game match starts, all piece cards of the game match are stored in the piece card pool; and a quantity of piece cards in the game match is conserved.

A quantity of effect cards stored in the effect card pool has no upper limit.

A quantity of equipment cards stored in the equipment card pool has no upper limit.

A quantity of chess player cards stored in the chess player card pool has no upper limit.

In an example, the effect card includes at least one of an exclusive effect card and a universal effect card.

The effect card pool includes at least one of an exclusive effect card pool and a universal effect card pool. The exclusive effect card pool is configured to store exclusive effect cards, and the universal effect card pool is configured to store universal effect cards.

The exclusive effect card is an effect card obtained by using a piece card having a reference piece attribute. A piece attribute includes at least one of a faction and a piece type.

The universal effect card is allowed to be obtained by using a piece card having any piece attribute.

In an example, the first card type includes a piece card; and the game match includes at least one game round.

The display module 801 is configured to additionally display a first quantity of piece cards when each of the at least one game round starts, the first quantity of piece cards including the first card.

In an examples, the apparatus further includes: a receiving module 802, configured to receive a first card dealing result, the first card dealing result carrying indication information of the first quantity of piece cards, and the first quantity of piece cards being randomly determined from the piece card pool.

In an example, the first card type includes an effect card.

The display module 801 is configured to additionally display a second quantity of effect cards in a case that deployed pieces of this party include a first piece and a use operation for a piece card corresponding to the first piece is received, the second quantity of effect cards including the first card.

In an example, the effect card includes at least one of an exclusive effect card and a universal effect card.

The display module 801 is configured to additionally display the second quantity of universal effect cards; or additionally display the second quantity of exclusive effect cards of a first type, the exclusive effect cards of the first type corresponding to a piece attribute of the first piece.

In an examples, the apparatus further includes: a receiving module 802, configured to receive a second card dealing result, the second card dealing result carrying indication information of the second quantity of universal effect cards, and the second quantity of universal effect cards being randomly determined from the universal effect card pool according to a chess player level of the chess player virtual character of this party; or a receiving module 802, configured to receive a third card dealing result, the third card dealing result carrying indication information of the second quantity of exclusive effect cards of the first type, and the second quantity of exclusive effect cards of the first type being randomly determined from the exclusive effect card pool according to the piece attribute of the first piece.

In an examples, the apparatus further includes: a card swapping module 803, configured to swap a first set of cards with a second set of cards in response to a card-swapping operation, the first set of cards including a to-be-swapped card selected by the card-swapping operation.

The second set of cards are determined according to card types included in the first set of cards and a quantity of cards of each card type, and the second set of cards have no overlap with the first set of cards.

In an example, in a case that the first set of cards includes a third quantity of piece cards, the second set of cards includes the third quantity of piece cards.

In a case that a total quantity of universal effect cards, exclusive effect cards, and chess player cards in the first set of cards is a fourth quantity, the second set of cards includes the fourth quantity of universal effect cards.

In a case that the first set of cards includes a fifth quantity of equipment cards, the second set of cards includes the fifth quantity of equipment cards.

In an example, the first set of cards includes the third quantity of piece cards.

The card swapping module 803 is configured to place the first set of cards back into the piece card pool.

The card swapping module 803 is configured to randomly determine the third quantity of piece cards from a candidate piece card pool to obtain the second set of cards, the candidate piece card pool including a card pool obtained after a first card having a same name is removed from the piece card pool, and the first card having the same name including a card whose card name is the same as that of a piece card in the first set of cards.

In an example, the total quantity of universal effect cards, exclusive effect cards, and chess player cards in the first set of cards is the fourth quantity.

The second set of cards includes the fourth quantity of universal effect cards randomly determined from a candidate universal effect card pool. The candidate universal effect card pool includes a card pool obtained after a second card having a same name is removed from the universal effect card pool, and the second card having the same name includes a card whose card name is the same as that of a universal effect card in the first set of cards.

In an example, the first set of cards includes the fifth quantity of equipment cards.

The second set of cards includes the fifth quantity of equipment cards randomly determined from a candidate equipment card pool. The candidate equipment card pool includes a card pool obtained after a third card having a same name is removed from the equipment card pool, and the third card having the same name includes a card whose card name is the same as that of an equipment card in the first set of cards.

In an example, the display module 801 is configured to display a card obtaining animation in a case that the first obtaining condition corresponding to the first card type is satisfied; and additionally display the first card after playback of the card obtaining animation is completed.

In an example, the first card type includes a piece card. The display module 801 is configured to additionally display, in a case that no piece having the same name as the first card exists in the deployed pieces of this party and in response to the use operation for the first card, a piece corresponding to the first card; or display, in a case that a piece having the same name as the first card exists in the deployed pieces of this party and in response to the use operation for the first card, that a piece level of the piece having the same name as the first card is increased, the piece having the same name as the first card including a piece whose piece name is the same as that of the piece corresponding to the first card.

In an example, the display module 801 is configured to display at least two candidate squares and a first indication element in response to the use operation for the first card, the first indication element including at least one of a zoomed-out first card, the piece corresponding to the first card, and a first indication arrow; and additionally display, in response to a drag operation of dragging the first indication element to a first candidate square, the piece corresponding to the first card in the first candidate square, the first candidate square being any one of the at least two candidate squares.

In an example, the first card type includes an equipment card. The display module 801 is configured to display a second indication element in response to the use operation for the first card, the second indication element including at least one of the zoomed-out first card, virtual equipment corresponding to the first card, and a second indication arrow; and additionally display, in response to a drag operation of dragging the second indication element to a piece of this party among the deployed pieces of this party, that the piece of this party is equipped with the virtual equipment corresponding to the first card.

The match playing apparatus for a round-based board game according to the foregoing example is described only using the division of the foregoing functional modules as an example. In practice, the foregoing functions may be allocated to and completed by different functional modules as required. In other words, an internal structure of a device is divided into different functional modules to complete all or some of the functions described above. In addition, the match playing apparatus for a round-based board game according to the foregoing example and the match playing method for a round-based board game according to the foregoing examples belong to the same concept. For details of the specific implementation process of the match playing apparatus for a round-based board game, refer to the method examples. Details are not described herein again.

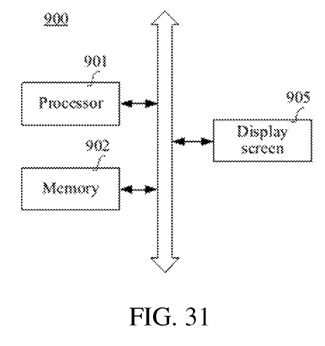

This application further provides a terminal, including a processor and a memory. The memory has at least one instruction stored therein, and the at least one instruction is loaded and executed by the processor, to cause the terminal to implement the match playing method for a round-based board game according to the foregoing method examples. The terminal may be a terminal provided in FIG. 31.

FIG. 31 is a structural block diagram of a terminal 900 according to an example of this application. The terminal 900 may be: a smartphone, a tablet computer, an MP3 player, an MP4 player, a notebook computer, or a desktop computer. The terminal 900 may alternatively be referred to as other names such as user equipment, a portable terminal, a laptop terminal, or a desktop terminal.

Typically, the terminal 900 includes: a processor 901 and a memory 902.

The processor 901 may include one or more processing cores, such as a 4-core processor or an 8-core processor. The processor 901 may be implemented by using at least one hardware form of a digital signal processor (DSP), a field-programmable gate array (FPGA), and a programmable logic array (PLA). The processor 901 may alternatively include a main processor and a coprocessor. The main processor is a processor configured to process data in an awaken state, and is also referred to as a central processing unit (CPU). The coprocessor is a low-power processor configured to process data in a standby state. In some examples, the processor 901 may be integrated with a graphics processing unit (GPU). The GPU is configured to render and draw content that needs to be displayed on a display screen. In some examples, the processor 901 may further include an artificial intelligence (AI) processor. The AI processor is configured to process computing operations related to machine learning.

The memory 902 may include one or more computer-readable storage media. The computer-readable storage medium may be non-transitory. The memory 902 may further include a high-speed random-access memory and a non-volatile memory, for example, one or more disk storage devices and flash storage devices. In some examples, the non-transitory computer-readable storage medium in the memory 902 is configured to store at least one instruction, and the at least one instruction is executed by the processor 901, to cause the terminal 900 to implement the match playing method for a round-based board game according to the method examples of this application. In some examples, a non-transitory memory may alternatively be referred to as a non-volatile memory.

In some examples, the terminal 900 may further include: a display screen 905.

The display screen 905 is configured to display a user interface (UI). The UI may include graphics, text, icons, videos, and any combination thereof. When the display screen 905 is a touch display screen, the display screen 905 further has a capability to collect a touch signal on or above a surface of the display screen 905. The touch signal may be inputted, as a control signal, into the processor 901 for processing. In this case, the display screen 905 may further be configured to provide a virtual button and/or a virtual keyboard, which are/is also referred to as a soft button and/or a soft keyboard. In some examples, one display screen 905 may be provided and disposed on a front panel of the terminal 900. In some other examples, at least two display screens 905 are provided and disposed on different surfaces of the terminal 900 or in a folded design. In some other examples, the display screen 905 may be a flexible display screen and disposed on a curved surface or a folded surface of the terminal 900. The display screen 905 may alternatively designed into a non-rectangular irregular shape, namely, a special-shaped screen. The display screen 905 may be prepared from a material such as a liquid crystal display (LCD) or an organic light-emitting diode (OLED).

A person skilled in the art may understand that the structure shown in FIG. 31 constitutes no limitation on the terminal 900, and the terminal may include more or fewer components than those shown in the figure, or some components may be combined, or a different component deployment may be used.

The memory further includes one or more programs. The one or more programs are stored in the memory, and include operations configured for implementing the match playing method for a round-based board game according to the examples of this application.

This application provides a non-volatile computer-readable storage medium, having at least one instruction stored therein. The at least one instruction is loaded and executed by a processor, to cause a computer to implement the match playing method for a round-based board game according to the foregoing method examples.

This application further provides a computer program product or computer program, including computer instructions. The computer instructions are stored in a non-volatile computer-readable storage medium. A processor of a computer device reads the computer instructions from the computer-readable storage medium, and executes the computer instructions, to cause the computer device to perform the match playing method for a round-based board game according to the foregoing implementations.

A person of ordinary skill in the art may understand that all or some of the operations for implementing the foregoing examples may be completed by hardware, or may be completed by a program instructing relevant hardware. The program may be stored in a non-volatile computer-readable storage medium. The storage medium mentioned above may be a read-only memory, a magnetic disk, an optical disc, or the like.

The above are merely examples of this application, but are not intended to limit this application. Any modification, equivalent replacement, improvement, or the like made within the principle of this application fall within the scope of protection of this application.

In this application, a prompt interface or a pop-up window may be displayed, or voice prompt information may be outputted before collection of user-related data and during collection of user-related data. The prompt interface, the pop-up window, or the voice prompt information is configured for prompting a user that user-related data is currently being collected. In this way, in this application, a related operation of obtaining the user-related data is performed only after a confirmation operation of the user for the prompt interface or the pop-up window is received. Otherwise (that is, no confirmation operation of the user for the prompt interface or the pop-up window is received), the related operation of obtaining the user-related data is terminated, that is, the user-related data is not obtained. In other words, all user data collected in this application is collected with consent and authorization of the user, and collection, use, and processing of the relevant user data need to comply with relevant laws, regulations, and standards of relevant countries and regions.

What is claimed is:

1. A match playing method for a round-based board game, performed by a computer device and comprising:
displaying a match interface of a game match of the round-based board game, the match interface comprising a chessboard area configured to display deployed pieces and a hand area configured to display cards held by a party, the cards comprising at least two card types;
additionally displaying a first card in the hand area based on determining that a first obtaining condition corresponding to a first card type is satisfied, the first card being a card of the first card type, the first card type being one of the at least two card types, and different card types corresponding to different obtaining conditions; and
displaying, in response to a use operation for the first card, that the first card acts on the game match of the round-based board game.

2. The method according to claim 1, wherein the at least two card types displayed in the hand area comprise at least two of the following card types: a piece card, an effect card, an equipment card, and a chess player card; and
the piece card is configured to summon a piece or upgrade a piece in the chessboard area; the effect card is configured to obtain a buff effect acting on the game match; the equipment card is configured to equip a piece with equipment; and the chess player card comprises a card obtained through a chess player skill of a chess player virtual character, and the chess player virtual character is a virtual character configured for controlling a piece.

3. The method according to claim 2, wherein the game match comprises at least one of the following card pools: a piece card pool, an effect card pool, an equipment card pool, and a chess player card pool;
the piece card pool is configured to store piece cards, and the piece card pool is a common card pool shared by all chess player virtual characters in the game match;
the effect card pool is configured to store effect cards, and the effect card pool is a common card pool shared by all chess player virtual characters in the game match;
the equipment card pool is configured to store equipment cards, and the equipment card pool is a common card pool shared by all chess player virtual characters in the game match; and
the chess player card pool is configured to store chess player cards, the chess player card pool corresponds to a chess player virtual character, and different chess player virtual characters correspond to different chess player card pools.

4. The method according to claim 3, wherein before the game match starts, all piece cards of the game match are stored in the piece card pool; and a quantity of piece cards in the game match is conserved;
a quantity of effect cards stored in the effect card pool has no upper limit;
a quantity of equipment cards stored in the equipment card pool has no upper limit; and
a quantity of chess player cards stored in the chess player card pool has no upper limit.

5. The method according to claim 3, wherein the effect card comprises at least one of an exclusive effect card and a universal effect card;
the effect card pool comprises at least one of an exclusive effect card pool and a universal effect card pool, the exclusive effect card pool is configured to store exclusive effect cards, and the universal effect card pool is configured to store universal effect cards;
the exclusive effect card is an effect card obtained by using a piece card having a reference piece attribute, and a piece attribute comprises at least one of a faction and a piece type; and
the universal effect card is allowed to be obtained by using a piece card having any piece attribute.

6. The method according to claim 2, wherein the first card type comprises a piece card, and the game match comprises at least one game round; and
the additionally displaying a first card in the game interface based on determining that a first obtaining condition corresponding to a first card type is satisfied comprises:
additionally displaying a first quantity of piece cards when each game round of the at least one game round starts, the first quantity of piece cards comprising the first card.

7. The method according to claim 6, further comprising:
receiving a first card dealing result, the first card dealing result carrying indication information of the first quantity of piece cards, and the first quantity of piece cards being randomly determined from a piece card pool.

8. The method according to claim 2, wherein the first card type comprises an effect card; and
the additionally displaying a first card in the game interface based on determining that a first obtaining condition corresponding to a first card type is satisfied comprises:
additionally displaying a second quantity of effect cards based on determining that deployed pieces of this party comprise a first piece and a use operation for a piece card corresponding to the first piece is received, the second quantity of effect cards comprising the first card.

9. The method according to claim 8, wherein the effect card comprises at least one of an exclusive effect card and a universal effect card; and
the additionally displaying a second quantity of effect cards comprises:
additionally displaying the second quantity of universal effect cards; or
additionally displaying the second quantity of exclusive effect cards of a first type, the exclusive effect cards of the first type corresponding to a piece attribute of the first piece.

10. The method according to claim 9, further comprising:
receiving a second card dealing result, the second card dealing result carrying indication information of the second quantity of universal effect cards, and the second quantity of universal effect cards being randomly determined from a universal effect card pool according to a chess player level of the chess player virtual character of this party; or
receiving a third card dealing result, the third card dealing result carrying indication information of the second quantity of exclusive effect cards of the first type, and the second quantity of exclusive effect cards of the first type being randomly determined from an exclusive effect card pool according to the piece attribute of the first piece.

11. The method according to claim 1, further comprising:
swapping a first set of cards with a second set of cards in response to a card-swapping operation, the first set of cards comprising a to-be-swapped card selected by the card-swapping operation,
the second set of cards being determined according to card types comprised in the first set of cards and a quantity of cards of each card type, and the second set of cards having no overlap with the first set of cards.

12. The method according to claim 11, wherein based on determining that the first set of cards comprises a third quantity of piece cards, the second set of cards comprises the third quantity of piece cards;
based on determining that a total quantity of universal effect cards, exclusive effect cards, and chess player cards in the first set of cards is a fourth quantity, the second set of cards comprises the fourth quantity of universal effect cards; or
based on determining that the first set of cards comprises a fifth quantity of equipment cards, the second set of cards comprises the fifth quantity of equipment cards.

13. The method according to claim 12, wherein the first set of cards comprises the third quantity of piece cards; and the method further comprises:
placing the first set of cards back into a piece card pool; and
randomly determining the third quantity of piece cards from a candidate piece card pool to obtain the second set of cards, the candidate piece card pool comprising a card pool obtained after a first card having a same name is removed from the piece card pool, and the first card having the same name comprising a card whose card name is the same as that of a piece card in the first set of cards.

14. The method according to claim 12, wherein the total quantity of universal effect cards, exclusive effect cards, and chess player cards in the first set of cards is the fourth quantity; and
the second set of cards comprises the fourth quantity of universal effect cards randomly determined from a candidate universal effect card pool; and the candidate universal effect card pool comprises a card pool obtained after a second card having a same name is removed from a universal effect card pool, and the second card having the same name comprises a card whose card name is the same as that of a universal effect card in the first set of cards.

15. The method according to claim 12, wherein the first set of cards comprises the fifth quantity of equipment cards; and
the second set of cards comprises the fifth quantity of equipment cards randomly determined from a candidate equipment card pool; and the candidate equipment card pool comprises a card pool obtained after a third card having a same name is removed from an equipment card pool, and the third card having the same name comprises a card whose card name is the same as that of an equipment card in the first set of cards.

16. The method according to claim 1, wherein the additionally displaying a first card in the game interface based on determining that a first obtaining condition corresponding to a first card type is satisfied comprises:
displaying a card obtaining animation based on determining that the first obtaining condition corresponding to the first card type is satisfied; and
additionally displaying the first card after playback of the card obtaining animation is completed.

17. The method according to claim 2, wherein the first card type comprises a piece card; and the displaying, in response to a use operation for the first card, that the first card acts on a game match of the round-based board game comprises:
additionally displaying, based on determining that no piece having the same name as the first card exists in the deployed pieces of this party and in response to the use operation for the first card, a piece corresponding to the first card, or
displaying, based on determining that a piece having the same name as the first card exists in the deployed pieces of this party and in response to the use operation for the first card, that a piece level of the piece having the same name as the first card is increased,
the piece having the same name as the first card comprising a piece whose piece name is the same as that of the piece corresponding to the first card.

18. A computer device for playing a round-based board game, comprising:
one or more processors; and
memory storing instructions that, when executed by the one or more processors, cause the computer device to:
display a match interface of a game match of the round-based board game, the match interface comprising a chessboard area configured to display deployed pieces and a hand area configured to display cards held by a party, the cards comprising at least two card types;
additionally display a first card in the hand area based on determining that a first obtaining condition corresponding to a first card type is satisfied, the first card being a card of the first card type, the first card type being one of the at least two card types, and different card types corresponding to different obtaining conditions; and
display, in response to a use operation for the first card, that the first card acts on the game match of the round-based board game.

19. The computer device according to claim 18, wherein the at least two card types displayed in the hand area comprise at least two of the following card types: a piece card, an effect card, an equipment card, and a chess player card; and
the piece card is configured to summon a piece or upgrade a piece in the chessboard area; the effect card is configured to obtain a buff effect acting on the game match; the equipment card is configured to equip a piece with equipment; and the chess player card comprises a card obtained through a chess player skill of a chess player virtual character, and the chess player virtual character is a virtual character configured for controlling a piece.

20. A non-transitory computer-readable storage medium storing instructions that, when executed by a processor, cause a computer device to:
display cards held by a party in a game interface, the cards comprising at least two card types;
additionally display a first card in the game interface based on determining that a first obtaining condition corresponding to a first card type is satisfied, the first card being a card of the first card type, the first card type being one of the at least two card types, and different card types corresponding to different obtaining conditions; and
display, in response to a use operation for the first card, that the first card acts on a game match of a round-based board game.
